(19) United States
(12) Patent Application Publication
(10) Pub. No.: US 2006/0017607 A1
(43) Pub. Date: Jan. 26, 2006

(54) Amplitude modulator, selector switch, high frequency transmitting/receiving apparatus including the same, and radar apparatus, and radar apparatus-mounting vehicle and radar apparatus-mounting small ship

(75) Inventors: Kazuki Hayata, Soraku-gun (JP); Yuji Kishida, Soraku-gun (JP); Nobuki Hiramatsu, Soraku-gun (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/190,337

(22) Filed: Jul. 26, 2005

(30) Foreign Application Priority Data
Jul. 26, 2004 (JP) P2004-217119

(51) Int. Cl. G01S 13/93; G01S 7/28; G01S 13/08

(52) U.S. Cl. 342/41; 342/70; 342/175; 342/118; 342/134

(57) ABSTRACT

An amplitude modulator in which modulator characteristics can be tuned is provided. In an amplitude modulator, between two high frequency transmission lines for transmitting high frequency signals, is provided a PIN diode which is a high frequency modulating element that modulates a high frequency signal input from one of the high frequency transmission lines and outputs the high frequency signal to an output terminal of the other of the high frequency transmission lines. A bias supply circuit includes a trimmable chip resistor which is a variable resistor for adjusting a bias current flowing through the PIN diode. By adjusting a resistance value, the bias current flowing through the PIN diode is controlled, so that it is possible to tune the modulator characteristics.

### BACKGROUND OF THE INVENTION

1. Field of the Invention

The present invention relates to an amplitude modulator for use in a millimeter wave integrated circuit, a millimeter wave radar module or the like, and more specifically, to an amplitude modulator in which modulator characteristics can be tuned with a variable resistor which is provided in a bias supply circuit of a high frequency modulation element which is a component of the amplitude modulator, and to a high frequency transmission/receiving apparatus having the amplitude modulator.

Furthermore, the present invention relates to a selector switch for use in a millimeter wave integrated circuit, a millimeter radar module or the like, and more specifically, relates to a selector switch whose transmission characteristics can be tuned by a variable resistor which is provided in a bias supply circuit of a PIN diode which is a component of the selector switch and a high frequency transmitting/receiving apparatus having the selector switch.

Furthermore, the present invention also relates to a radar apparatus having the high frequency transmitting/receiving apparatus, a vehicle equipped with the radar apparatus, and a small ship equipped with the radar apparatus.

2. Description of the Related Art

Examples of related-art amplitude modulators are those disclosed in “NRD guide high speed ASK modulator using Schottky barrier diode” by Futoshi Kuroki, Kengo Ikeda, and Tsutomu Yoneyama, in Proceedings of the General Conference of Electronic Information Communications Society, 1997, Incorporated Association Electronic Information Communications Society, published on Mar. 6, 1997, Vol.1, C-2-65, p.120; Japanese Unexamined Patent Publication JP-A 10-270944 (1998); and U.S. Pat. No. 6,034,574. For example, in the amplitude modulators disclosed in JP-A 10-270944 and U.S. Pat. No. 6,034,574, a detecting diode is provided at an end portion of a high frequency transmission line that transmits high frequency signals, and a signal source for controlling a bias, a high frequency choke and a resistor are connected to this detecting diode. In such an amplitude modulator, it is known that as a high frequency transmission line, a nonradiative dielectric waveguide (hereinafter, referred to as “NRD guide”) is preferably used.

The basic configuration of this nonradiative dielectric waveguide is, as shown in a partially cut perspective view in FIG. 18, such that a dielectric waveguide 53 whose cross section on one virtual plane that is perpendicular to the waveguide extending direction is quadrangular such as rectangular is provided between parallel plate conductors 51 and 52 that are arranged in parallel with a predetermined space a. If this predetermined space a is a ≦λ/2 with respect to the wavelength λ of a high frequency signal, noise does not enter the dielectric waveguide 53 from the outside, and a high frequency is not radiated to the outside so that high frequency signals are propagated through the dielectric waveguide 53 efficiently. The wavelength λ of the high frequency signal is a wavelength in the air (free space) at a frequency used.

In the amplitude modulator having such a configuration, the detecting diode operates as a high frequency modulating element for modulating high frequency signals, and also serves to detect the high frequency signals. For example, as adetecting diode that performs such a function with respect to high frequency signals in the millimeter wave band, in general, Schottky barrier diodes are known. Furthermore, in such a configuration, a resistor functions as consuming means for consuming the detected output of the detecting diode.

Moreover, there have been proposed high frequency transmitting/receiving apparatuses designed to operate in combination with such an amplitude modulator as a high frequency circuit element, which are expected to find applications in a millimeter wave radar module, a millimeter wave wireless radio communications apparatus, or the like. For example, such a high frequency transmitting/receiving apparatus is disclosed in Japanese Unexamined Patent Publication JP-A2000-258525. The high frequency transmitting/receiving apparatus disclosed in JP-A 2000-258525 is of the type that adopts a pulse modulation scheme.

FIG. 19 is a schematic block circuit diagram showing the conventional high frequency transmitting/receiving apparatus that adopts the pulse modulation scheme. For example, the high frequency transmitting/receiving apparatus is composed of: a high frequency oscillator 61 for generatinga high-frequency signal; abranching device 62 connected relatively to the output end of the high frequency oscillator 61, for branching the high frequency signal so that the branched high frequency signal components may be outputted to one output end 62 b and the other output end 62 c thereof, respectively; an amplitude modulator 63 connected relatively to the one output end 62 b of the branching device 62, for modulating part of the high frequency signal so as to put it out as a high-frequency signal intended for transmission; a circulator 64 having a first terminal 64a, a second terminal 64b, and a third terminal 64c, of which the first terminal 64a is connected with the output end 63a of the amplitude modulator 63, wherein a high frequency signal inputted from the first terminal 64 a is outputted to the second terminal 64 b, and a high-frequency signal inputted from the second terminal 64 b is outputted to the third terminal 64c; a transmitting/receiving antenna 65 connected to the second terminal 64 b of the circulator 64; and a mixer 66 connected between the other output end 62 c of the branching device 62 and the third terminal 64 c of the circulator 64, for mixing the high frequency signal outputted to the other output end 62 c of the branching device 62 as a local signal L0 and a high frequency signal received by the transmitting/receiving antenna 65 so as to generate an intermediate frequency signal.

It has been known that, in such a conventional high frequency transmitting/receiving apparatus, a nonradiative dielectric waveguide is suitable for use as a high frequency transmission line for providing connection among the high frequency circuit elements and transmitting high frequency signals (refer to JP-A 2000-258525, for example).

Furthermore, one example of a conventional radar apparatus provided with such a high frequency transmitting/receiving apparatus and a vehicle equipped with the radar apparatus is disclosed in Japanese Unexamined Patent Publication JP-A 2003-35768.

However, in the conventional amplitude modulators as disclosed in JP-A 10-270944 (1998) and U.S. Pat. No. 6,034,574, an adjusting (tuning) mechanism for tuning the transmission characteristics of high frequency signals that are transmitted through the amplitude modulator, which are modulator characteristics, after incorporating the amplitude modulator as a high frequency circuit element into a module or other elements as described above is not provided, so that it is difficult to tune the modulator characteristics in the state in which the amplitude modulator is incorporated into a module or the like. Therefore, for example, it is difficult to keep the output of the amplitude modulator constant with respect to variations in the characteristics of the high frequency circuit element.

In addition, in the conventional high frequency transmitting/receiving apparatus having such an amplitude modulator, because of tuning inaccuracy or instability in the amplitude modulator, it is impossible to ensure a uniform output of high frequency signals for transmission. This gives rise to a problem of difficulty in attaining excellent characteristics with stability.

Furthermore, in the case where the high frequency oscillator 61 and the amplitude modulator 63 or the high frequency oscillator 61 and the mixer 66 are connected selectively, using a RF (radio frequency) switch, instead of the branching device 62, it is difficult to tune the transmission characteristics of the RF switch, and in a conventional high frequency transmitting/receiving apparatus provided with such a RF switch, because of tuning inaccuracy or instability in the RF switch, it is impossible to ensure a uniform output of high frequency signals for transmission. This gives rise to a problem of difficulty in attaining excellent characteristics with stability.

In a radar apparatus using such a high frequency transmitting/receiving apparatus, erroneous detection tends to occur because the output of the high frequency signals for transmission is not stable, and therefore detection of an object to be detected is delayed.

Further, in the vehicle or small ship equipped with such a radar apparatus, an objected to be detected is detected by the radar apparatus. In response to the detected information, the vehicle or small ship takes proper action such as collision avoidance and braking. However, because of the delay of target detection, an abrupt action is caused in the vehicle or small ship after the detection operation.

### SUMMARY OF THE INVENTION

In the light of the above, objects of the invention are to provide an amplitude modulator capable of tuning the modulator characteristics in a simple manner by a bias supply circuit of a high frequency modulating element which is a component of the amplitude modulator, and to provide a high performance high frequency transmitting/receiving apparatus capable of stabilizing high frequency signals for transmission at a predetermined output intensity with a simple configuration by being provided with such an amplitude modulator.

Furthermore, other objects of the invention are to provide a selector switch capable of tuning the transmission characteristics of the selector switch in a simple manner by a bias supply circuit of a PIN diode which is a component of the selector switch, and to provide a high performance high frequency transmitting/receiving apparatus capable of stabilizing high frequency signals for transmission with a predetermined output intensity with a simple configuration by being provided with such a selector switch.

In addition, further another object of the invention is to provide a radar apparatus having the high performance high frequency transmitting/receiving apparatus, a vehicle equipped with the radar apparatus, and a small ship equipped with the radar apparatus.

The invention provides an amplitude modulator comprising:

two high frequency transmission lines for transmitting high frequency signals;

a high frequency modulating element that is provided between the high frequency transmission lines and that modulates a high frequency signal input from one of the high frequency transmission lines and outputs the high frequency signal to the other of the high frequency transmission lines; and

a bias supply circuit that is connected to the high frequency modulating element and supplies a bias voltage to the high frequency modulating element,

wherein the bias supply circuit includes a variable resistor for adjusting a bias current flowing through the high frequency modulating element.

According to the invention, in the amplitude modulator, between two high frequency transmission lines for transmitting high frequency signals is provided a high frequency modulating element that modulates a high frequency signal input from one of the high frequency transmission lines and outputs the high frequency signal to the other of the high frequency transmission lines, and a bias supply circuit that is connected to the high frequency modulating element includes a variable resistor for adjusting a bias current flowing through the high frequency modulating element. Therefore, the variable resistor sets the bias current to an appropriate value with respect to the high frequency modulating element and operates so as to adjust the transmission characteristics of the high frequency signal transmitted through the amplitude modulator, which are modulator characteristics, so that an amplitude modulator can be obtained in which the modulator characteristic can be tuned with the variable resistor in a simple manner even after the amplitude modulator is incorporated into a module or the like.

In the invention, it is preferable that the variable resistor is constituted by a trimmable chip resistor.

According to the invention, when the variable resistor is constituted by a trimmable chip resistor, the resistance value that has been set can be held reliably, even if the ambient conditions such as vibration are added after the resistance value has been adjusted because the trimmable chip resistor has no variable portion. Therefore, an amplitude modulator whose modulator characteristics are stabilized can be obtained.

In the invention, it is preferable that the variable resistor is constituted by a trimmer potentiometer.

According to the invention, when the variable resistor is constituted by a trimmer potentiometer, the modulator characteristics can be further stabilized for the following reason. Since the trimmer potentiometer serves to set the resistance value dynamically in accordance with a control signal that is externally input, tuning can be performed so that desired modulator characteristics can be obtained, in spite of changes in environment conditions such as ambient temperature or the like or temporal changes in the characteristics of the high frequency modulating element.

In the invention, it is preferable that the high frequency modulating element is constituted by a PIN diode.

According to the invention, when the high frequency modulating element is constituted by a PIN diode, an amplitude modulator can be obtained in which even if the intensity of the high frequency signal that is input is changed, the modulator characteristics can be relatively stable for the following reason. Since the PIN diode has no detecting function with respect to high frequency signals, for example, signals in the millimeter wave band, when modulating such a high frequency signal, even if the intensity of the high frequency signal that is input is changed, the bias current flowing through the PIN diode is not changed thereby, so that the transmission characteristics of the high frequency signal transmitted through the PIN diode can be stabilized.

The invention provides a selector switch comprising:

an input side high frequency transmission line having an input terminal:

two output side high frequency transmission lines each having an output terminal;

PIN diodes, one of which is provided between the input side high frequency transmission line and one of the output side high frequency transmission lines, and another of which is provided between the input side high frequency transmission line and the other of the output side high frequency transmission lines; and

a bias supply circuit provided so as to individually correspond to each of the PIN diodes, for supplying a bias voltage to the PIN diodes,

wherein the bias supply circuit includes a variable resistor for adjusting a bias current flowing through the PIN diodes.

According to the invention, in a selector switch, when a high frequency signal is supplied to an input terminal of an input side high frequency transmission line, the high frequency signal is supplied to each PIN diode. A bias supply circuit that is provided so as to correspond to the PIN diode and that can apply a bias voltage is individually connected to the PIN diode, and the bias supply circuit includes a variable circuit for adjusting a bias current flowing through the PIN diodes. Therefore, the variable resistor sets the bias current to an appropriate value with respect to the PIN diode and operates so as to adjust the transmission characteristics of the high frequency signal transmitted through the PIN diode, so that a selector switch can be obtained in which the modulator characteristic can be tuned with the variable resistor in a simple manner even after the selector switch is incorporated into a module or the like.

Furthermore, since the PIN diode is used, the transmission characteristics of the selector switch advantageously can be relatively stable, even if the intensity of the high frequency signal that is input is changed for the following reason. Since the PIN diode has no detecting function with respect to high frequency signals, for example, signals in the millimeter wave band, even if, when transmitting such a high frequency signal in the state in which the switch is on, in other words, when transmitting such a high frequency signal in a state in which a bias current is supplied to the PIN diode, the intensity of the high frequency signal that is input is changed, the bias current flowing through the PIN diode is not changed, so that the transmission characteristics of the high frequency signal transmitted through the PIN diode can be stabilized.

In the invention, it is preferable that the variable resistor is constituted by a trimmable chip resistor.

According to the invention, the variable resistor is constituted by a trimmable chip resistor. The resistance value that has been set can be held reliably, even if the ambient conditions such as vibration are added after the resistance value has been adjusted, because the trimmable chip resistor has no variable portion. Therefore, an amplitude modulator whose modulator characteristics are stabilized can be obtained.

The invention provides a high frequency transmitting/receiving apparatus comprising:

a high frequency oscillator for generating a high frequency signal;

a branching device having two output portions and connected to the high frequency oscillator, for branching the high frequency signal supplied from the high frequency oscillator and outputting signals from one of the two output portions and the other of the two output portions;

the amplitude modulator mentioned above in, which the one of the high frequency transmission lines is connected to the one output portion of the branching device, for modulating a high frequency signal branched to the one output portion and outputting a high frequency signal for transmission from the other high frequency transmission line;

a signal divider having a first terminal, a second terminal and a third terminal, the other of the high frequency transmission lines of the amplitude modulator being connected to the first terminal, the high frequency signal for transmission input from the first terminal being output from the second terminal, the high frequency signal input from the second terminal being output from the third terminal;

an antenna for transmission/reception that is connected to the second terminal; and

a mixer that is connected between the other: output portion of the branching device and the third terminal, for mixing the high frequency signal that is branched and output from the other output portion and a high frequency signal received at the antenna for transmission/reception and outputting an intermediate frequency signal.

According to the invention, in a high frequency transmitting/receiving apparatus, a high frequency signal oscillated from a high frequency oscillator is supplied to a branching device and branched at the branching device, and the branched high frequency signals are output from one output portion and another output portion of the branching device. The high frequency signal output from the one output portion is supplied to the one of the high frequency transmission lines of the amplitude modulator andmodulated, and supplied to a first terminal of a signal divider as a high frequency signal for transmission. The signal divider outputs the high frequency signal for transmission input to the first terminal from the second terminal, and the high frequency signal for transmission is radiated from an antenna for transmission/reception that is connected to the second terminal as a ratio wave. The high frequency signal received by the antenna for transmission/reception is supplied to the second terminal, and the signal divider outputs the high frequency signal supplied to the second terminal from the third terminal. The signal divider can divide the high frequency signal for transmission supplied to the antenna for transmission/reception and the high frequency signal received by the antenna for transmission/reception. The high frequency signal output from the third terminal is supplied to a mixer, and, at the same time, to the mixer, a high frequency signal is supplied from the branching device, so that the mixer mixes the high frequency signal received by the antenna for transmission/reception and the high frequency signal that is oscillated from the high frequency oscillator but not yet modulated by the modulator and outputs an intermediate frequency signal. In such a high frequency transmitting/receiving apparatus, the amplitude modulator serves to tune the modulator characteristics in accordance with the characteristics of the high frequency modulating element or its mounting state, resulting in a high performance high frequency transmitting/receiving apparatus in which good transmission output can be obtained stably. Furthermore, when the amplitude modulator includes a trimmable chip resistor or a trimmer potentiometer, the trimmable chip resistor or the trimmer potentiometer can hold a predetermined resistance value stably even under an environment in which vibration or temperature changes are extreme, and therefore, even in such an environment, good modulator characteristics can be maintained. Therefore, a high frequency transmitting/receiving apparatus with constantly stable performance can be obtained.

The invention provides a high frequency transmitting/receiving apparatus comprising:

a high frequency oscillator for generating a high frequency signal;

a branching device having two output portions and connected to the high frequency oscillator, for branching the high frequency signal supplied from the high frequency oscillator and outputting signals from one of the two output portions and the other of the two output portions;

the amplitude modulator mentioned above in which the one of the high frequency transmission lines is connected to the one output portion of the branching device, for modulating a high frequency signal branched to the one output portion and outputting a high frequency signal for transmission from the other high frequency, transmission line;

an isolator having an input terminal and an output terminal, for, when supplied with a high frequency signal for transmission at the input terminal from the amplitude modulator, outputting the high frequency signal for transmission from the output terminal;

an antenna for transmission that is connected to the output terminal;

an antenna for reception; and

a mixer that is connected to the other output portion of the branching device and the antenna for reception, for mixing the high frequency signal that is branched and output from the other output portion and a high frequency signal received at the antenna for reception and outputting an intermediate frequency signal.

According to the invention, in a high frequency transmitting/receiving apparatus, a high frequency signal oscillated from a high frequency oscillator is supplied to a branching device and branched at the branching device, and the branched high frequency signals are output from one output portion and another output portion of the branching device. The high frequency signal output from the one output portion is supplied to the one of the high frequency transmission lines of the amplitude modulator and modulated, and supplied to an input terminal of an isolator as a high frequency signal for transmission. The isolator transmits the high frequency signal for transmission supplied to its input terminal and outputs the high frequency signal for transmission from the output terminal, and the high frequency signal for transmission is radiated from an antenna for transmission that is connected to the output terminal as a ratio wave. The high frequency signal received by the antenna for reception is supplied to a mixer, and, at the same time, to the mixer, a high frequency signal is supplied from the branching device, so that the mixer mixes the high frequency signal received by the antenna for reception and the high frequency signal that is oscillated from the high frequency oscillator but not yet modulated by the modulator and outputs an intermediate frequency signal. In such a high frequency transmitting/receiving apparatus using separate antennas, one of which is for transmission and another for reception, the amplitude modulator serves to tune the modulator characteristics in accordance with the characteristics of the high frequency modulating element or its mounting state, resulting in a high performance high frequency transmitting/receiving apparatus in which good transmission output can be obtained stably. Furthermore, when the amplitude modulator includes a trimmable chip resistor or a trimmer potentiometer, the tritmable chip resistor or the trimmer potentiometer can hold a predetermined resistance value stably even under an environment in which vibration or temperature changes are extreme, and therefore, even in such an environment, good modulator characteristics can be maintained. Therefore, a high frequency transmitting/receiving apparatus with constantly stable performance can be obtained.

The invention provides a high frequency transmitting/receiving apparatus comprising:

a high frequency oscillator for generating a high frequency signal;

the selector switch mentioned above, whose input terminal is connected to the high frequency oscillator, for selectively outputting the high frequency signal supplied from the high frequency oscillator, from the one and the other output side high frequency transmission line;

a signal divider having a first terminal, a second terminal and a third terminal, an output terminal of the one of the output side high frequency signal transmission lines of the selector switch being connected to the first terminal, the high frequency signal input from the first terminal being output from the second terminal, the high frequency signal input from the second terminal being output from the third terminal;

an antenna for transmission/reception that is connected to the second terminal; and

a mixer that is connected to an output terminal of the other of the output side high frequency transmission lines of the selector switch and the third terminal, for mixing the high frequency signal that is output from the output terminal of the other of the output side high frequency transmission lines and a high frequency signal received at the antenna for transmission/reception and outputting an intermediate frequency signal.

According to the invention, in a high frequency transmitting/receiving apparatus, a high frequency signal oscillated from a high frequency oscillator is supplied to an input terminal of a selector switch. The selector switch outputs the high frequency signal supplied from the high frequency oscillator by selectively switching the output terminal of the one of the output side high frequency transmission lines and the output terminal of the other of the output side high frequency transmission lines. The high frequency signal output from the output terminal of the one of the output side high frequency transmission lines is supplied to a first terminal of a signal divider as a high frequency signal for transmission. The signal divider outputs the high frequency signal for transmission input to the first terminal from the second terminal, and the high frequency signal for transmission is radiated from an antenna for transmission/reception that is connected to the second terminal as a ratio wave. The high frequency signal received by the antenna for transmission/reception is supplied to the second terminal, and the signal divider outputs the high frequency signal supplied to the second terminal from the third terminal. The signal divider can divide the high frequency signal for transmission supplied to the antenna for transmission/reception and the high frequency signal received by the antenna for transmission/reception. The high frequency signal output from the third terminal is supplied to a mixer, and, at the same time, to the mixer, a high frequency signal output from the output terminal of the other of the output side high frequency transmission lines of the selector switch is supplied as a local signal and the mixer mixes the high frequency signal received by the antenna for transmission/reception and the high frequency signal that is oscillated from the high frequency oscillator and outputs an intermediate frequency signal. In such a high frequency transmitting/receiving apparatus, the selector switch serves to tune the transmission characteristics of the selector switch in accordance with the characteristics of the PIN diode as a switching element or its mounting state, resulting in a high performance high frequency transmitting/receiving apparatus in which good transmission output can be obtained stably. Furthermore, when the selector switch includes a trimmable chip resistor, the trimmable chip resistor can hold a predetermined resistance value stably even under an environment in which vibration or temperature changes are extreme, and therefore, even in such an environment, good modulator characteristics can be maintained. Therefore, a high frequency transmitting/receiving apparatus with constantly stable performance can be obtained.

The invention provide a high frequency transmitting/receiving apparatus comprising:

a high frequency oscillator for generating a high frequency signal;

the selector switch mentioned above, whose input terminal is connected to the high frequency oscillator, for selectively outputting the high frequency signal supplied from the high frequency oscillator, from the one and the other output side high frequency transmission line;

an antenna for transmission that is connected to an output-terminal of the one of the high frequency transmission lines;

an antenna for reception; and

a mixer that is connected to an output terminal of the other of the output side high frequency transmission lines of the selector switch and the antenna for reception, for mixing the high frequency signal that is output from the output terminal of the other of the output side high frequency transmission lines and a high frequency signal received at the antenna for reception and outputting an intermediate frequency signal.

According to the invention, in a high frequency transmitting/receiving apparatus, a high frequency signal oscillated from a high frequency oscillator is supplied to an input terminal of a selector switch. The selector switch outputs the high frequency signal supplied from the high frequency oscillator by selectively switching the output terminal of the one of the output side high frequency transmission lines and the output terminal of the other of the output side high frequency transmission lines. The high frequency signal output from the output terminal of the one of the output side high frequency transmission lines is supplied to an antenna for transmission as a high frequency signal for transmission, and is radiated from an antenna for transmission/reception as a ratio wave. The high frequency signal received by the antenna for reception is supplied to a mixer, and, at the same time, to the mixer, a high frequency signal output from another output portion of the selector switch is supplied as a local signal so that the mixer mixes the high frequency signal received by the antenna for reception and the high frequency signal that is oscillated from the high frequency oscillator and outputs an intermediate frequency signal. Also in such a high frequency transmitting/receiving apparatus using separate antennas, one of which is for transmission and another for reception, the selector switch serves to tune the transmission characteristics of the selector switch in accordance with the characteristics of the PIN diode as a switching element or its mounting state, resulting in a high performance high frequency transmitting/receiving apparatus in which good transmission output can be obtained stably. Furthermore, when the selector switch includes a trimmable chip resistor, the trimmable chip resistor can hold a predetermined resistance value stably even under an environment in which vibration or temperature changes are extreme, and therefore, even in such an environment, good characteristics of the selector switch can be maintained. Therefore, a high frequency transmitting/receiving apparatus with constantly stable performance can be obtained.

The invention provides a radar apparatus comprising:

the high frequency transmitting/receiving apparatus mentioned above; and

a distance information detecting device for processing the intermediate frequency signal output from the high frequency transmitting/receiving apparatus and detecting information on a distance up to an object to be detected.

According to the invention, a radar apparatus comprises the high frequency transmitting/receiving apparatus mentioned above, and distance information detecting device for processing the intermediate frequency signal output from the high frequency transmitting/receiving apparatus and detecting information on a distance up to an object to be detected. Therefore, the high frequency transmitting/receiving apparatus transmits high frequency signal for transmission stably at good transmission output, so that a radar apparatus that can detect an object to be detected fast and reliably and an object to be detected that is near or far away fast and reliably. Furthermore, with the high frequency transmitting/receiving apparatus of the invention that provides stable performance even in an environment in which vibration, temperature changes or the like are extreme, a radar apparatus that operates even under such extreme conditions can be obtained.

The invention provides a radar apparatus-mounting vehicle comprising the radar apparatus mentioned above, which is used to detect an object to be detected.

According to the invention, a radar apparatus-mounting vehicle comprises the radar apparatus mentioned above, which is used to detect an object to be detected. Since the radar apparatus can detect fast and reliably another vehicle or an obstacle, which is an object to be detected, appropriate control of the vehicle and appropriate warning to the driver can be performed without causing the vehicle to perform a sudden action, for example, to avoid the obstacle.

The invention provides a radar apparatus-mounting small ship comprising the radar apparatus mentioned above, which is used to detect an object to be detected.

According to the invention, the radar apparatus-mounting small ship comprises the radar apparatus mentioned above, which is used to detect an object to be detected. Since the radar apparatus can detect fast and reliably another small ship or an obstacle, which is an object to be detected, appropriate control of the small ship and appropriate warning to the driver can be performed without causing the small ship to perform a sudden action, for example, to avoid the obstacle.

### BRIEF DESCRIPTION OF THE DRAWINGS

Other and further objects, features, and advantages of the invention will be more explicit from the following detailed description taken with reference to the drawings wherein:

FIG. 1 is a schematic block circuit diagram showing a configuration of an amplitude modulator according to one embodiment of the invention;

FIGS. 2A and 2B are schematic perspective view and plan view showing the amplitude modulator shown in FIG. 1, respectively;

FIG. 3 is a schematic plan view showing an example of a high frequency modulating portion M in the amplitude modulator shown in FIGS. 2A and 2B;

FIG. 4 is a schematic plan view showing the configuration of an amplitude modulator according to another embodiment of the invention;

FIG. 5 is a schematic plan view showing the configuration of a selector switch according to one embodiment of the invention;

FIGS. 6A and 6B are schematic plan view and side view showing an example of a trimmable chip resistor which is a component of a bias supply circuit shown in FIG. 1;

FIGS. 7A to 7E are schematic plan views showing an example of another trimming method in the trimmable chip resistor shown in the FIGS. 6A and 6B, respectively;

FIG. 8 is a perspective view showing a configuration of a trimmer potentiometer;

FIG. 9 is a schematic block circuit diagram showing a configuration of a high frequency transmitting/receiving apparatus according to a first embodiment of the invention;

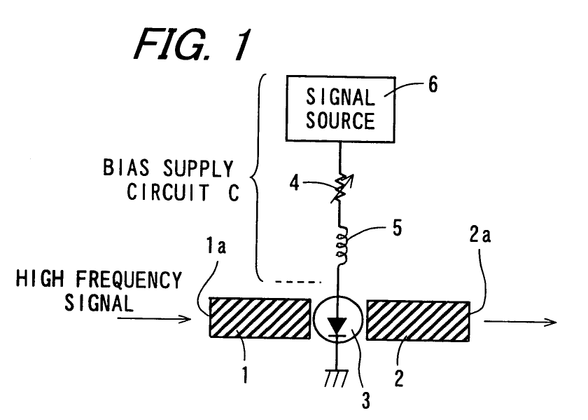

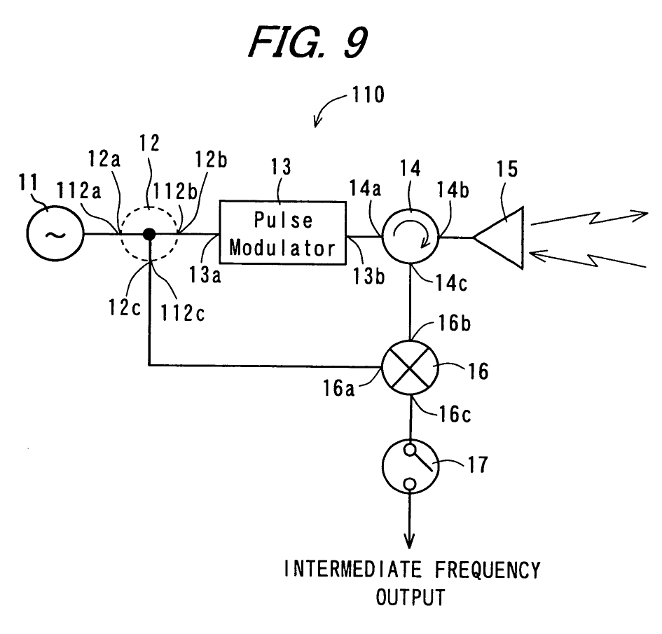

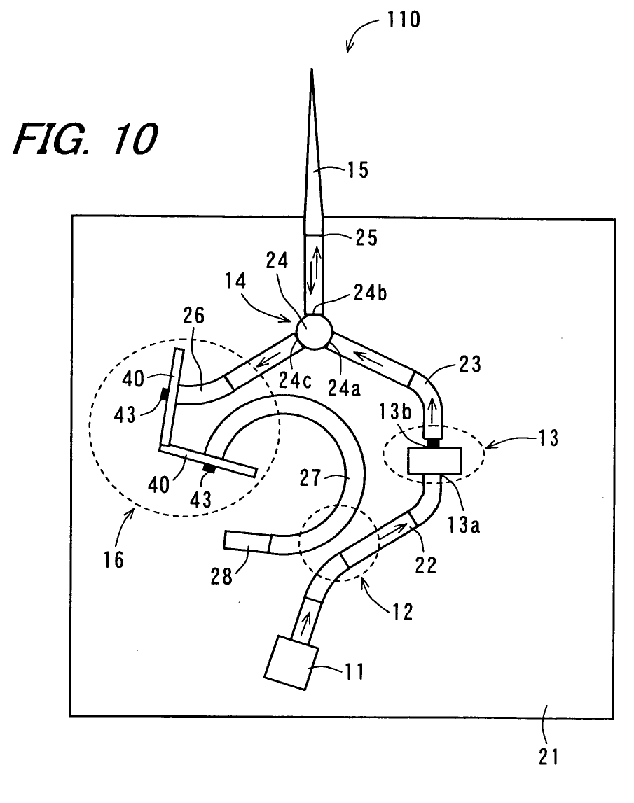

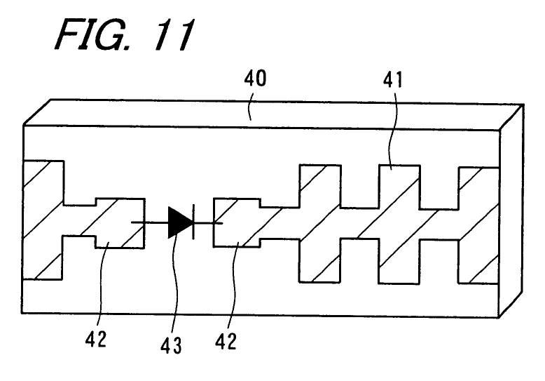

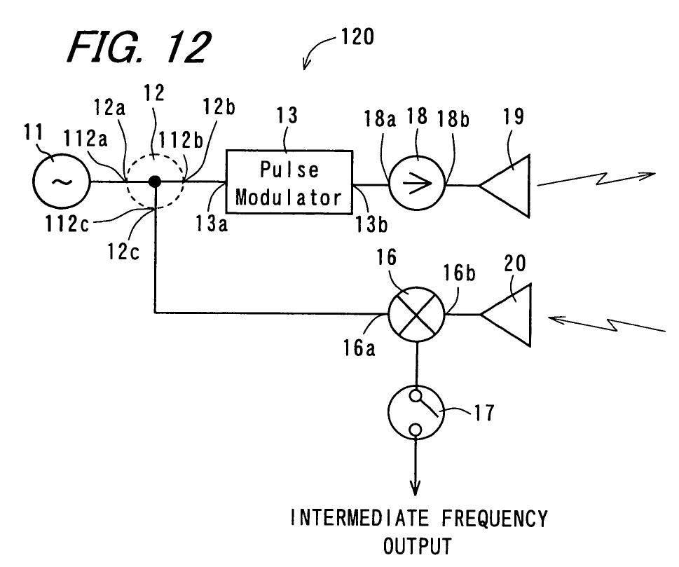

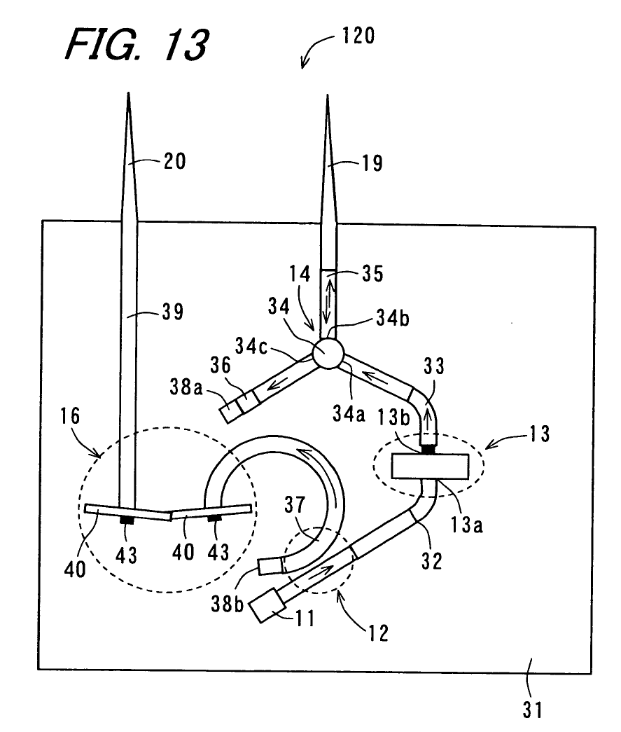

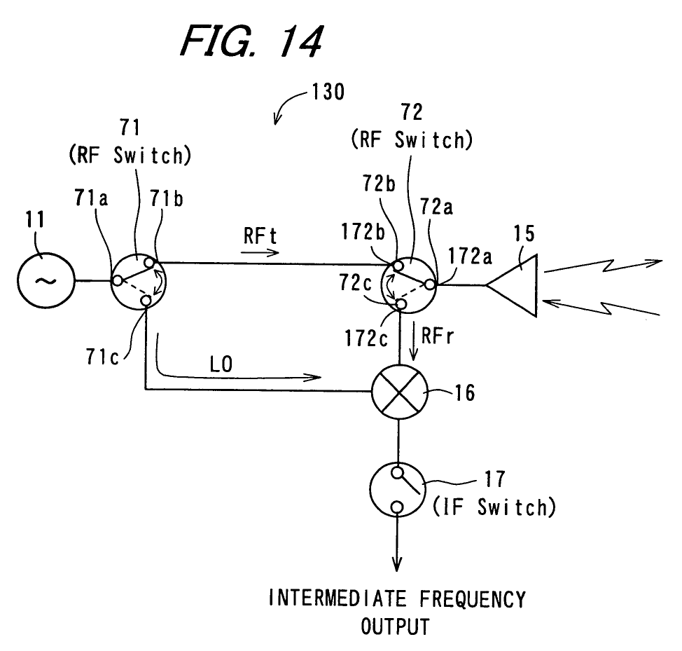

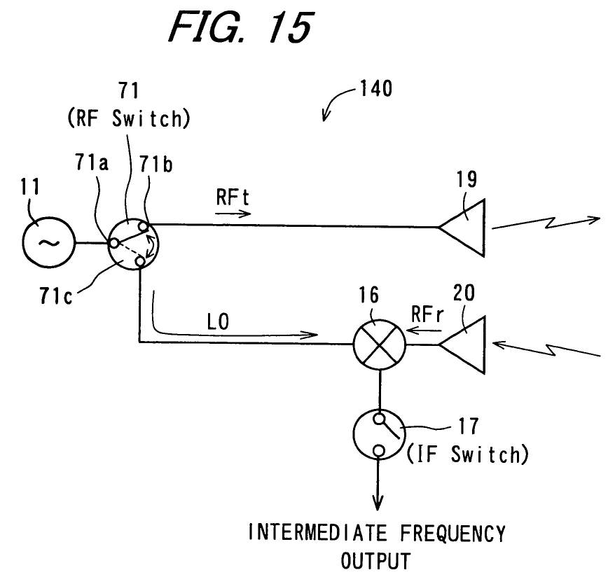

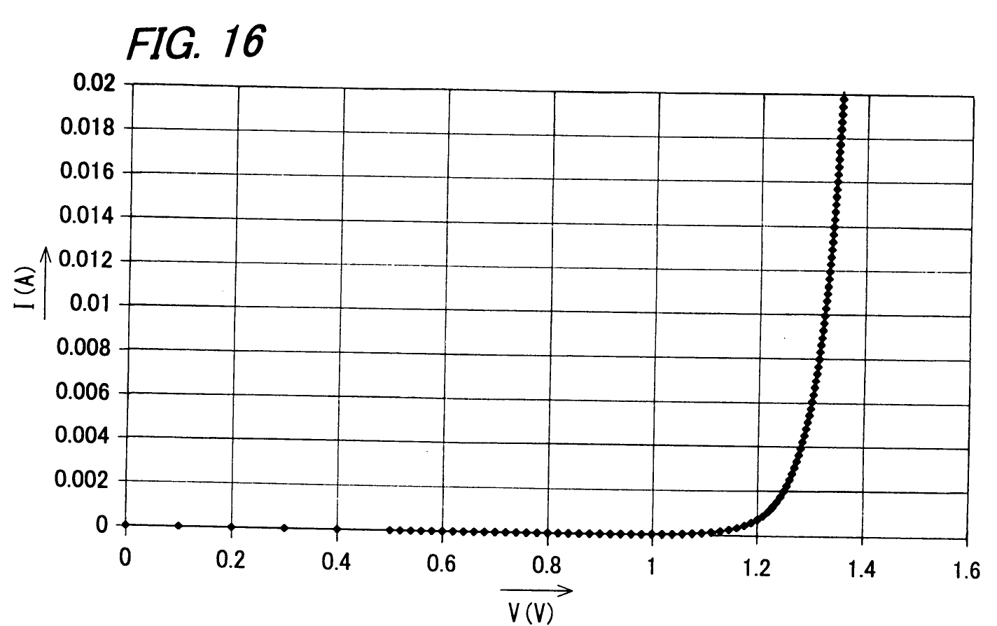

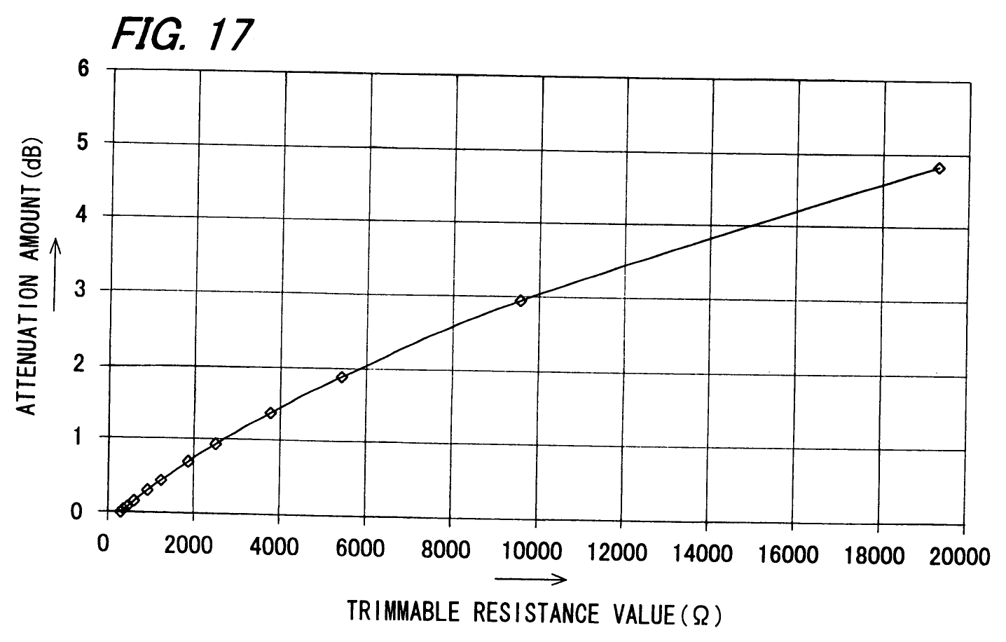

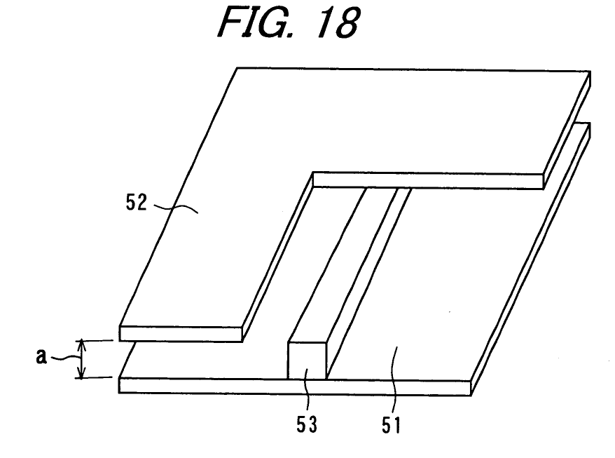

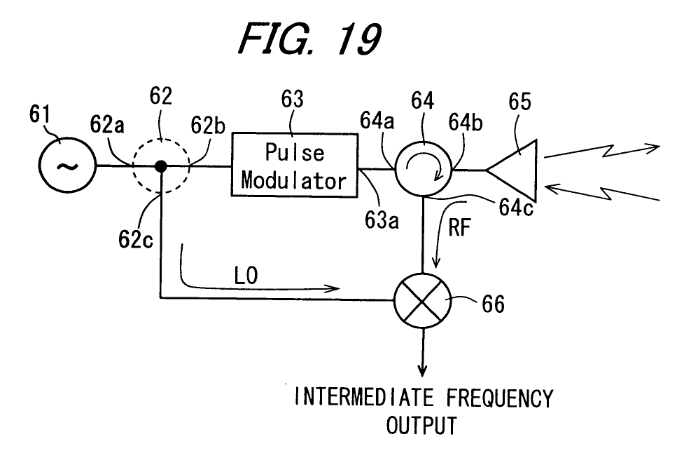

FIG. 1O is a schematic plan view of the high frequency transmitting/receiving apparatus shown in FIG. 9;

FIG. 11 is a schematic perspective view showing one example of a substrate on which a diode for a mixer featuring a nonradiative dielectric waveguide is mounted;

FIG. 12 is a schematic block circuit diagram showing a configuration of a high frequency transmitting/receiving apparatus according to a second embodiment of the invention;

FIG. 13 is as schematic plan view of the high frequency transmitting/receiving apparatus shown in FIG. 12;

FIG. 14 is a schematic block circuit diagram showing a configuration of a high frequency transmitting/receiving apparatus according to a third embodiment of the invention;

FIG. 15 is a schematic block circuit diagram showing a configuration of a high frequency transmitting/receiving apparatus according to a fourth embodiment of the invention;

FIG. 16 is a graph showing a relationship between a bias current and a bias voltage applied to a PIN diode;

FIG. 17 is a graph showing a relationship between a resistance value of the trimmable chip resistor and an attenuation amount of a high frequency signal;

FIG. 18 is a partially cut perspective view showing a basic configuration of a nonradiative dielectric waveguide; and

FIG. 19 is a schematic block circuit diagram showing an example of a conventional high frequency transmitting/receiving apparatus.

### DETAILED DESCRIPTION OF THE PREFERED EMBODIMENTS

Now referring to the drawings, preferred embodiments of the invention are described below.

At the outset, an amplitude modulator, a selector switch, a high-frequency transmitting/receiving apparatus having the amplitude modulator and the selector switch embodying the invention will be described in detail with reference to the accompanying drawings.

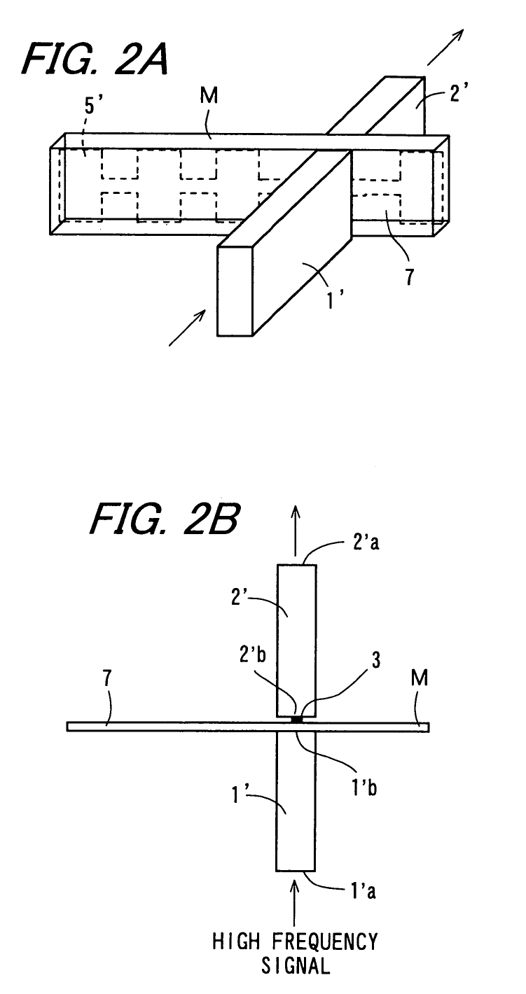

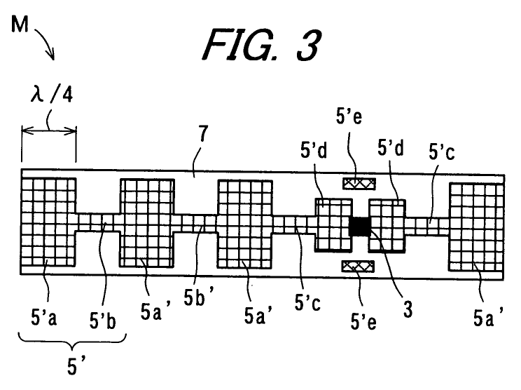

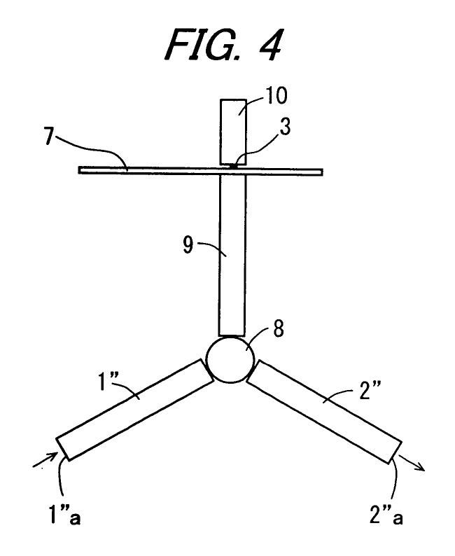

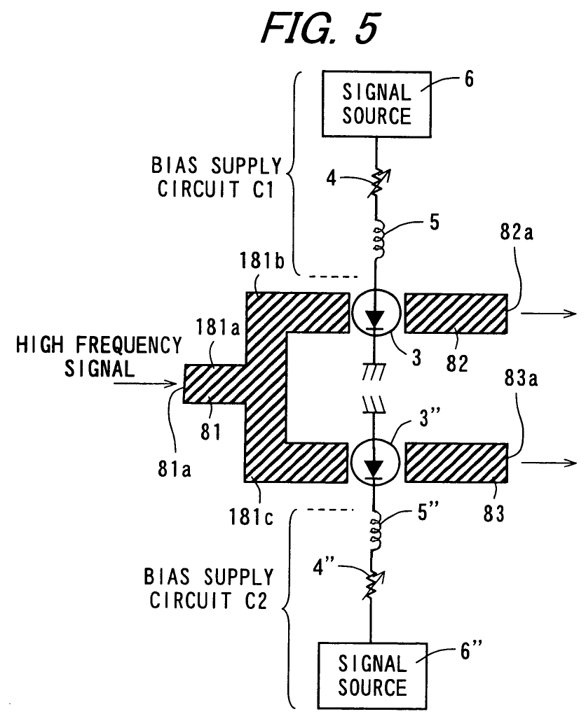

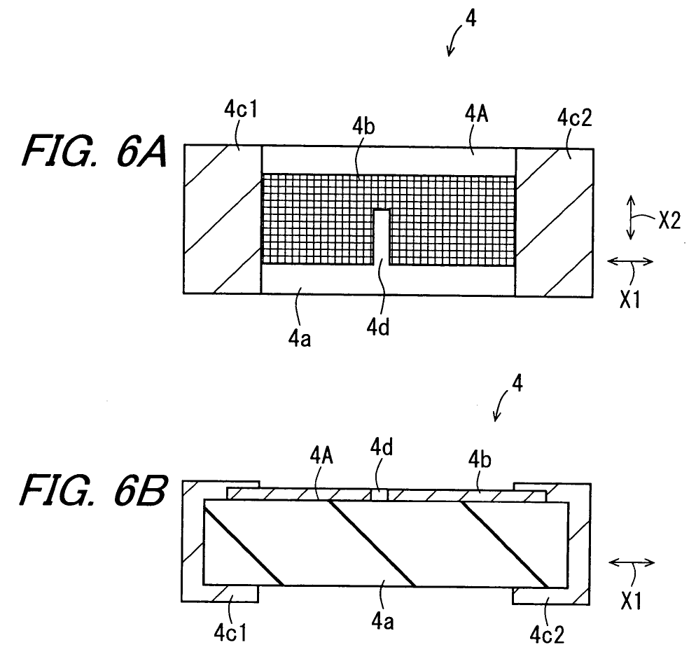

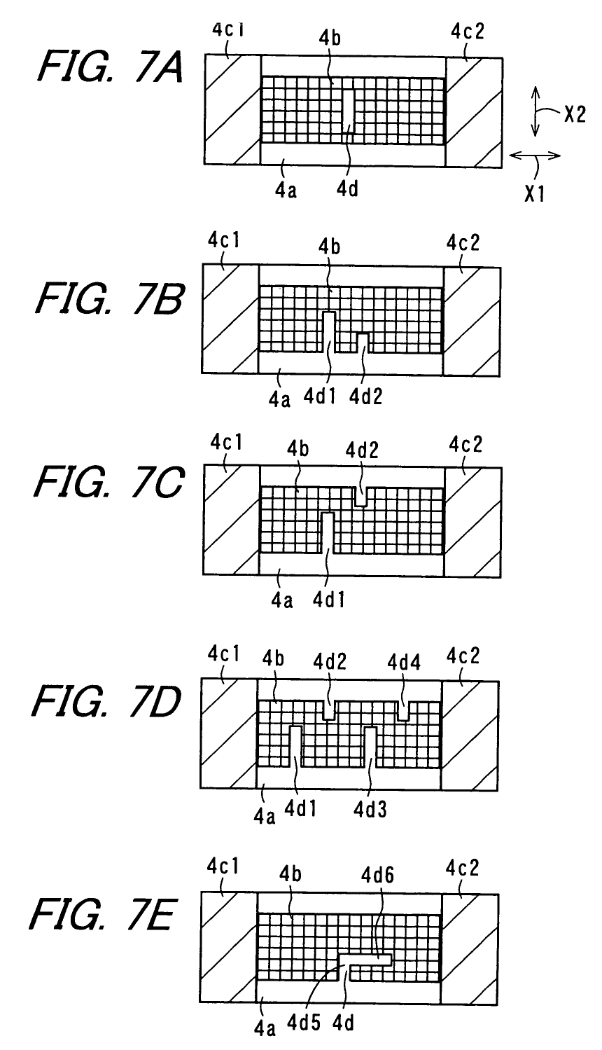

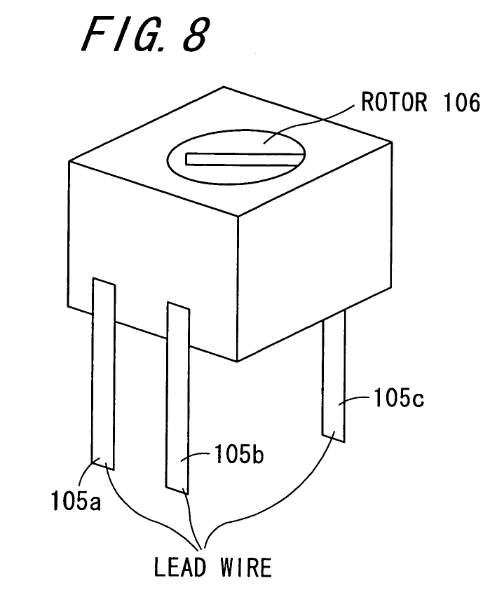

FIG. 1 is a schematic block circuit diagram showing a configuration of an amplitude modulator according to one embodiment of the invention. FIGS. 2A and 2B are schematic perspective view and plan view showing the amplitude modulator shown in FIG. 1, respectively. FIG. 3 is a schematic plan view showing an example of a high frequency modulating portion in the amplitude modulator shown in FIGS. 2A and 2B. FIG. 4 is a schematic plan view showing the configuration of an amplitude modulator according to another embodiment of the invention. FIG. 5 is a schematic plan view showing the configuration of a selector switch according to one embodiment of the invention. FIGS. 6A and 6B are schematic views showing an example of a trimmable chip resistor 4 which is a component of a bias supply circuit C in the amplitude modulator shown in FIG. 1. FIG. 6A is a plan view and FIG. 6B is a side view thereof. FIGS. 7A to 7E are schematic plan views showing an example of another trimming method in the trimmable chip resistor 4 shown in the FIGS. 6A and 6B, respectively. FIG. 8 is a perspective view showing a configuration of a trimmer potentiometer 104. FIG. 9 is a schematic block circuit diagram showing a configuration of a high frequency transmitting/receiving apparatus 110 according to a first embodiment of the invention. FIG. 10 is a schematic plan view of the high frequency transmitting/receiving apparatus 110 shown in FIG. 9. FIG. 11 is a schematic perspective view showing one example of a substrate on which a diode for a mixer featuring a nonradiative dielectric waveguide is mounted. FIG. 12 is a schematic block circuit diagram showing a configuration of a high frequency transmitting/receiving apparatus 120 according to a second embodiment of the invention. FIG. 13 is a schematic plan view of the high frequency transmitting/receiving apparatus 120 shown in FIG. 12. FIG. 14 is a schematic block circuit diagram showing a configuration of a high frequency transmitting/receiving apparatus 130 according to a third embodiment of the invention. FIG. 15 is a schematic block circuit diagram showing a configuration of a high frequency transmitting/receiving apparatus 140 according to a fourth embodiment of the invention. FIG. 16 is a graph showing the relationship between a bias current and a bias voltage applied to a PIN diode 3. FIG. 17 is a graph showing a relationship between a resistance value of the trimmable chip resistor 4 and a attenuation amount of a high frequency signal. FIG. 18 is a partially cut perspective view showing a basic configuration of a nonradiative dielectric waveguide.

In FIGS. 1 to 7E, reference numerals 1 and 2 denote high frequency transmission lines; 1a and 2a denote an input terminal and an output terminal; 1′ and 1″ denote dielectric waveguides for input; 2′ and 2″ denote dielectric waveguides for output; 1′a and 1″a, and 2′a and 2″ a denote input terminals and output terminals (these terminals are ends on one side of the dielectric waveguides 1′ and 2′); 1′b and 2′b denote end portions (these end portions are the other ends of the dielectric waveguides 1′ and 2′) ; 3 and 3″ denote PIN diodes; 4 and 4″ denote trimmable chip resistors; 4a denotes a dielectric substrate; 4b denotes a resistor layer; 4c1 and 3c2 denote electrodes; 4d and 3d1 to 3d4 denote trimming portions; 5 and 5″ denote choke inductors; 5′ denotes choke type bias supply line, 5′a denotes a wide line; 5′b denotes a narrow line; 5′c denotes a line conductor; 5′d denotes a conductor for connection; 5′e denotes an island-shaped conductor; 6 and 6″ denote signal sources; 7 denotes a substrate; 8 denotes a ferrite plate; 9 denotes a dielectric waveguide; 10 denotes a non reflective terminator; 81, 82 and 83 denote transmission lines for high frequencies; 81a denotes an input terminal; and 82a and 83a denote output terminals.

In FIGS. 9 to 15, reference numeral 11 denotes a high frequency oscillator; 12 denotes a branching device; 13 denotes a modulator; 14 denotes a circulator constituting a signal divider; 15 denotes a transmitting/receiving antenna; 16 denotes a mixer; 17 denotes a switch; 18 denotes an isolator; 19 denotes an antenna for transmission; 20 denotes an antenna for reception; 21 and 31 denote plate conductors; 22 and 32 denote first dielectric waveguides; 23 and 33 denote second dielectric waveguides; 24 and 34 denote ferrite plates as magnetic bodies; 25 and 35 denote third dielectric waveguides; 26 and 36 denote fourth dielectric waveguides; 27 and 37 denote fifth dielectric waveguides; 28, 38a and 38b denote nonreflective terminators; 39 denotes a sixth dielectric waveguide; 40 denotes a substrate; 41 denotes a choke type bias supply line; 42 denotes a terminal for connection; 43 denotes an element for detecting high frequencies; 12a denotes an input terminal; 12b denotes one output terminal; 12c denotes another output terminal; 13a and 18a denote input terminals; 13b and 18b denote output terminals; 14a, 24a and 34a denote first terminals; 14b, 24b and 34b denote second terminals; and 14c, 24c and 34c denote third terminals. Furthermore, reference numeral 71 denotes a selector switch (RF switch) ; 72 denotes a second selector switch (RF switch) constituting a signal divider; 7la denotes an input terminal; 71b denotes one output terminal; 71c denotes another output terminal; 72a denotes an input/output terminal; 72b denotes an input terminal; and 72c denotes an output terminal. In FIG. 18, reference numerals 51 and 52 denote plate conductors, and 53 denotes a dielectric waveguide.

In FIGS. 2A, 2B and 4, the plate conductors are not shown. In FIGS. 10 and 13, the upper plate conductors are not shown.

The amplitude modulator according to one embodiment of the invention has the following configuration as shown in a schematic circuit diagram in FIG. 1. A PIN diode 3 serving as a high frequency modulating element for modulating a high frequency signal input from the high frequency transmission line 1 on one side and outputting the modulated signal onto the output terminal 2a side of the high frequency transmission line 2 on the other side is provided between two high frequency transmission lines 1 and 2 for transmitting high frequency signals. A bias supply circuit C that is connected to the PIN diode 3 includes a trimmable chip resistor 4 serving as a variable resistor that adjusts a bias current flowing through the PIN diode 3. In this configuration, a choke inductor 5 and a signal source 6 are further connected in the bias circuit C, and thus the trimmable chip resistor 4, the choke inductor 5 and the signal source 6 are connected to the PIN diode 3.

The signal source 6 supplies a bias voltage to the PIN diode 3 via the trimmable chip resistor 4 and the choke inductor 5. The signal source 6 supplies a bias voltage to the PIN diode 3 based on a control signal for amplitude-modulating an externally supplied high frequency signal, and herein applies selectively either a constant forward direction bias voltage and a constant reverse direction bias voltage or a voltage of 0V. The cathode of the PIN diode 3 is grounded, and the anode is connected to the choke inductor 5. More specifically, the trimmable chip resistor 4 is connected between the choke inductor 5 and the signal source 6.

In the amplitude modulator shown in FIG. 1, the high frequency transmission lines 1 and 2 are constituted by nonradiative dielectric waveguides, and as shown in a perspective view and a plan view in FIGS. 2A and 2B, between plate conductors (not shown) provided in parallel with a gap of ½ or less of the wavelength of a high frequency signal, dielectric waveguides 1′ and 2′ for input and output are arranged with the PIN diode 3 of a high frequency modulating portion M interposed between their opposing end portions 1′b and 2′b. In the high frequency modulating portion M, the PIN diode 3 is connected to a choke type bias supply line 5′ formed on a substrate 7 shown in a plan view of FIG. 3. The dielectric waveguide 1′ for input and the dielectric waveguide 2′ for output are provided along their extending direction. The end portion l′b of the dielectric waveguide 1′ for input on the side of the dielectric waveguide 2′ for output is in contact with one surface in the thickness direction of the substrate 7, and the end portion 2′b of the dielectric waveguide 2′ for output on the side of the dielectric waveguide 1′ for input is in contact with the PIN diode 3 that is mounted on the other surface in the thickness direction of the substrate 7.

The choke type bias supply line 5′ corresponds to the choke inductor 5. The dielectric waveguides 1′ and 2′ correspond to the high frequency transmission lines 1 and 2 in FIG. 1, respectively.

More specifically, in the above configuration, in the choke type bias supply line 5′ formed on the substrate 7, as shown in the plan view of FIG. 3, a wide line 5′a and a narrow line 5′b are connected alternately with a length of a λ/4 (λ is the wavelength of a high frequency signal transmitted to the dielectric waveguides 1′ and 2′) period, and a line conductor 5′c and a conductor 5′d for connection are provided in a portion where the alternate arrangement is interrupted. The substrate 7 is formed of a material having electrical insulating properties. In FIG. 3, for clarification, the wide line 5′a, the narrow line 5′b and the conductor 5′d for connection are gridded. The wide line 5′a, the narrow line 5′b, the line conductor 5′c and the conductor 5′d for connection are formed of a maternal having a conductivity on the other surface in the thickness direction of the substrate 7 in such a manner that their centers in their width direction are matched to each other. The width direction is the direction perpendicular to the direction in which the choke type bias supply line 5′ extends and the thickness direction of the choke type bias supply line 5′. The shapes of the wide line 5′a, the narrow line 5′b, the line conductor 5′c and the conductor 5′d for connection when viewed from one side of the thickness direction are rectangular. The PIN diode 3 is provided in a portion where the chock type bias supply line 5′ is interrupted, between the two conductors 5′d provided a part in such a manner that the PIN diode 3 is connected to the two conductor 5′d for connection. The anode of the PIN diode 3 is connected to one of the conductors 5′d for connection, and the cathode of the PIN diode 3 is connected to the other conductor 5′d for connection. The wide line 5′a , the narrow line 5′b, the line conductor 5′c and the conductor 5′d for connection on one side (the left side of FIG. 3) with respect to the PIN diode 3 of the choke type bias supply line 5′ are integrally formed, and the wide line 5′a, the line conductor 5′c and the conductor 5′d for connection on the other side (the right side of FIG. 3) with respect to the PIN diode 3 of the choke type bias supply line 5′ are integrally formed.

Furthermore, island-shaped conductors 5′e having a conductivity are provided in the vicinity of the conductors 5′d for connection on both sides on the substrate 7. More specifically, the island-shape conductors 5′e are provided near to the opposing end portions of the conductors 5′d for connection, on both sides of the conductors 5′d for connection in the width direction, apart from the conductors 5′d for connection, on both sides of the PIN diode 3 in the width direction, apart from the PIN diode 3. When positioning the high frequency modulating portion M between the end portions 1′b and 2′b of the dielectric waveguides 1′ and 2′, the PIN diode 3 is provided on the substrate 7 such that high frequency signals transmitted through the dielectric waveguides 1′ and 2′ enter the PIN diode 3 and a current flows in a direction substantially parallel to the direction of the electric field of its LSE mode, and the PIN diode 3 is connected to the conductor 5′d forconnection. The bias supply circuit C (not shown) is connected to one end (left end portion in FIG. 3) of extending direction of the choke type bias supply line 5′ so that a bias is supplied to the PIN diode 3, and the other end (right end portion in FIG. 3) of extending direction of the choke type bias supply line 5′ is grounded. In order to connect the PIN diode 3 to the conductor 5′d for connection on the substrate 7, flip chip connection or wire bonding connection may be performed.

When a forward direction bias voltage is applied to the PIN diode 3, the PIN diode 3 transmits a high frequency signal, and when a reverse direction bias voltage is applied or no voltage is applied to the PIN diode 3, the PIN diode 3 does not transmit but reflect a high frequency signal.

Furthermore, as shown in a plan view of FIG. 4, the amplitude modulator according to another embodiment of the invention includes two ferrite plates 8, and a dielectric waveguide 1″ for input, a dielectric waveguide 9 for modulation, a nonreflective terminator 10 and a dielectric waveguide 2″ for output which are provided radially with respect to the two ferrite plates 8, between plate conductors (not shown) arranged in parallel with a gap of ½ or less of the wavelength of a high frequency signal. The two ferrite plates 8 are arranged opposed to and apart from each other in the inner faces of the plate conductors. High frequency signals are input to the dielectric waveguide 1″ for input. The PIN diode 3 is provided in a leading end portion of the dielectric waveguide 9, which is on the opposite side of the ferrite plate 8, for modulation. The nonreflective terminator 10 is provided in the extended direction of the leading end portion of the dielectric waveguide 9 for modulation to terminate the high frequency signals that have been transmitted through the PIN diode 3. The dielectric waveguide 2″ for output outputs the high frequency signals whose amplitudes have been modulated by the PIN diode 3. The PIN diode 3 is connected to the bias circuit C (not shown) in which the trimmable chip resistor 4 for adjusting a bias current flowing through the PIN diode 3, the choke inductor 5 and the signal source 6 are connected as the configuration shown in FIG. 1. The dielectric waveguide 1″ for input, the dielectric waveguide 9 for modulation, and dielectric waveguide 2″ for output extend along the plate conductor, and extend radially from the positions that are displaced by 120 degrees each around the axis perpendicular to the ferrite plane 8.

More specifically, in the above-described configuration, the PIN diode 3 is connected to the conductor 5′d for connection of the choke type bias supply line 5′ on the substrate 7 that is similar to that shown in FIG. 3. The substrate 7 connected to the PIN diode 3 is provided in the leading end portion of the dielectric waveguide 9 for modulation such that high frequency signals enter the PIN diode 3 from the dielectric waveguide 9 for modulation, and the nonreflective terminator 10 is provided in the extended direction of the dielectric waveguide 9 for modulation such that the high frequency signals having transmitted through the PIN diode 3 enter the nonrelfective terminator 10 but are terminated. The arrangement of the PIN diode 3 with respect to the dielectric waveguide 9 for modulation is the same as the arrangement of the PIN diode 3 with respect to the dielectric waveguide 1′ shown in FIG. 2 described above. The arrangement of the PIN diode 3 with respect to the nonreflective terminator 10 is the same as the arrangement of the PIN diode 3 with respect to the dielectric waveguide 2′ shown in FIG. 2 described above.

A selector switch of one embodiment of the invention shown in FIG. 5 includes an input side high frequency transmission line 81 having an input terminal 81a, two output side high frequency transmission lines 82 and 83 having output terminals 82a and 83a, respectively. Hereinafter, the output terminal 82a of the one of the output side high frequency transmission lines 82 may be referred to as one output terminal 82a, and the output terminal 83a of the other of the output side high frequency transmission lines 83 may be referred to as another output terminal 83a. The PIN diodes 3 and 3″ are providedbetween the input terminal 81a and the one output terminal 82a and between the input terminal 81a and the other output terminal 83a, in other words, between the input side high frequency transmission line 81 and the one of the output side high frequency transmission lines 82, and between the input side high frequency transmission line 81 and the other of the output side high frequency transmission lines 83, respectively. To the PIN diodes 3 and 3″ are connected bias supply circuits C1 and C2 that individually correspond to these PIN diodes 3 and 3″ and that apply a bias voltage. The bias supply circuit C1 for applying a bias voltage is connected to the PIN diode 3, and the bias supply circuit C2 for applying a bias voltage is connected to the PIN diodes 3″. These supply circuits C1 and C2 include trimmable chip resistors 4 and 4″ as variable resistors for adjusting the bias current flowing through the PIN diodes 3 and 3″. By individually providing the bias supply circuits C1 and C2 with the trimmable chip resistors 4 and 4″, it is possible to individually adjust a current flowing through the PIN diodes 3 and 3″. In the selector switch shown in FIG. 5, the same components as in the configuration of the amplitude modulator described above bear the same reference numerals. The anode of the PIN diode 3″ is grounded, and the cathode is connected to the choke inductor 5″. The choke inductor 5″ is connected to the signal source 6″ via the trimmable chip resistor 4″. The bias supply circuit C2 is constituted by the choke inductor 5″, the trimmable chip resistor 4″ and the signal source 6″.

The input side high frequency transmission line 81 has an input portion 181a having an input terminal 81a, and two branched portions 181b and 181c that are branched from the end portion opposite to the input terminal 81a of the input portion 181a. The PIN diode 3 is provided between the end portion opposite to the input portion 181a of the first branched portion 181b and the end portion opposite to the output portion 82a of the one of the output side high frequency transmission lines 82. The PIN diode 3″ is provided between the end portion opposite to the input portion 181a of the second branched portion 181c and the end portion opposite to the output portion 83a of the other of output side high frequency transmission lines 83. The arrangement relationship between the first branched portion 181b, the PIN diode 3, and the one of the output side high frequency transmission lines 82 and the arrangement relationship between the second branched portion 181c, the PIN diode 3″, and the other of the output side high frequency transmission lines 83 are the same as the arrangement relationship between the one of the high frequency transmission lines 1, the PIN diode 3, and the other of the high frequency transmission lines 2 of the amplitude modulator shown in FIG. 1 described above.

More specifically, the bias supply circuits C1 and C2 that are the same as the bias supply circuit C in the example of the amplitude modulator shown in FIG. 1 are connected to the two PIN diodes 3 and 3″, respectively. The signal sources 6 and 6″ supply bias voltages such that a forward bias voltage is applied to either one of the PIN diodes 3 and 3″ and a reverse bias voltage is applied to the other, and that a high frequency signal input to the input terminal 81a is output from the one output terminal 82a or the other output terminal 83a. That is to say, the signal sources 6 and 6″ supply bias voltages such that when a forward bias voltage is applied to either one of the PIN diodes 3 and 3″, a reverse bias voltage is applied to the other, and that when a forward bias voltage is applied to either of the other PIN diodes 3 and 3″, a reverse bias voltage is applied to the other. The signal sources 6 and 6″ supply bias voltages to the PIN diodes 3 and 3″ in the manner as described above, based on external control signals.

Even more specifically, in the amplitude modulators having the above-described configurations shown in FIGS. 1 to 4 and the selector switch shown in FIG. 5, as shown in FIGS. 6A and 6B, for the trimmable chip resistor 4 (hereinafter, the same applies to the trimmable chip resistor 4′), a resistor layer 4b made of a resisting material such as a Ni—Cr (nickel—chrome) alloy is formed on a dielectric substrate 4a made of a dielectric such as alumina ceramics, namely on one surface 4A in a thickness direction of the dielectric substrate 4a, and electrodes 4c1 and 4c2 are formed so as to be connected to the opposite end portions of the resistor layer 4b and cover the opposite end portions of the dielectric substrate 4a. The resistor layer 4b of the trimmable chip resistor 4 is irradiated with laser light from a YAG (yttrium—aluminum—garnet) laser or the like to oxidize an appropriate area of a portion of the resistor layer 4b to form a trimming portion 4d made of metal oxide having electrical insulating properties, and thus a resistance value between the electrodes 4c1 and 4c2 can be changed.

The both end portions of the resistor layer 4b are, that is, the both end portions in a predetermined direction along the one surface 4A of the dielectric substrate 4a in the resistor layer 4b, and are the both end portions in the longitudinal direction X1. The both end portions of the resistor layer 4a are, that is, the both end portions in a predetermined direction along the one surface 4A of the dielectric substrate 4a, and are the end portions in the longitudinal direction X1. The electrodes 4c1 and 4c2 are formed of a metal material having a lower specific resistance than that of the resistor layer 4b, by plating solder, aluminum, copper or the like. The resistor layer 4b can be realized with a metal thin film having a rectangular parallelepiped shape. The resistor layer 4b is formed in a region excluding the peripheral portion on the one surface 4A in the thickness direction of the dielectric substrate 4a, and the both end portions in the longitudinal direction X1 are in contact with the electrodes 4c1 and 4c2.

The trimmable chip resistor 4 may include a protective film having electrical insulating properties for covering the resistor layer 4b between the electrodes 4c1 and 4c2. The protective film transmits about 99% of light of a YAG laser. Such a protective film eliminates the necessity of performing a process of protecting the resistor layer 4b separately after trimming, which facilitates the post treatment. Moreover, since the resistor layer 4b is protected by the protective film, the resistance value of the resistor layer 4b is prevented from changing so that the resistance value that is stable can be maintained in the trimmable chip resistor 4.

This trimmable chip resistor 4 can be used as follows. As shown in FIGS. 6A and 6B, a peripheral portion of the resistor layer 4b in which the electrodes 4c1 and 4c2 are not connected is irradiated with a YAG laser light in parallel with a width direction X2 of the resistor layer 4b from the outer side toward the inner side so that linear oxidized portion is provided to form the trimming portion 4d. The area of the linear oxidized portion changes the resistance value of the trimmable chip resistor 4, and as this area increases, the cross sectional area of the cross section of the resistor layer 4b in which a current flows decreases, so that the resistance value can be increased.

When oxidizing the resistor layer 4b, for example, in the region that has been irradiated with laser light, all the portions on one surface through the other surface in the thickness direction of the resistor layer 4b may be oxidized, or only one surface portion in the region that has been irradiated with laser light may be oxidized.

When the resistance value of the trimmable chip resistor 4 is adjusted, in general, it is possible to select a relatively small resistance value in a desired adjustment range as an initial value, and adjust the resistance value so as to be increased.

When increasing the area of the linear oxidized portion, the width of the trimming portion 4d is set to a predetermined width that can be determined by the spot size of the YAG laser light, and the YAG laser light scans in one direction, so that the area may be increased in the scanning direction. In this case, before the next scanning, the same portion is irradiated with the pulsed YAG laser light a plurality of times. With this, adjustment (trimming) of the resistance value can be performed with a high accuracy.

In this embodiment, the resistance value of the resistor layer 4b is changed by oxidizing a portion of the resistor layer 4b. However, in another embodiment of the invention, the resistance value of the resistor layer 4b may be changed by cutting out a portion of the resistor layer 4b by a laser.

Besides the linear oxidized portion shown in FIGS. 6A and 6B, a trimming portion 4d in which the liner oxidized portion is provided in the central portion of the resistor layer 4b, as shown in a plan view of FIG. 7A, may be formed. Alternatively, as shown in FIG. 7B, after the linear oxidized portion is provided as a first oxidized portion 4d1, a similar linear oxidized portion that is shorter than the first oxidized portion 4d1 may be provided as a second oxidized portion 4d2 in a position slightly apart from the first oxidized portion 4d1 (double oxidization). The direction in which the first oxidized portion 4d1 extends is parallel to the direction in which the second oxidized portion 4d2 extends. The first oxidized portion 4d 1 and the second oxidized portion 4d2 are formed so as not to be connected, and it is preferable that the end of the first oxidized portion 4d1 on the second oxidized portion 4d2 side and the end of the second oxidized portion 4d2 on the first oxidized portion 4d1 side are formed apart by a predetermined distance in the direction perpendicular to the direction in which the first oxidized portion 4d1 and the second oxidized portion 4d2 extend and the thickness direction of the resistor layer 2b, that is, the longitudinal direction X1 of the resistor layer 2b.

As shown in FIG. 7C, as opposed to such double oxidization, double oxidizations in which the second oxidized portion 4d2 is provided on the side opposite to the side on which the first oxidized portion 4d1 is provided may be formed. As shown in FIG. 7D, the double oxidized portions 4d1 and 4d2 shown in FIG. 7C and the similar double oxidizations 4d3 and 4d4 may be provided in a comb shape (serpentine oxidization). When the trimming portions 4d, 4d1 to 4d4 are formed as shown in FIGS. 7B to 7D, the second oxidized portions 4d2 and 4d4 serve to set the resistance value more delicately, so that higher accurate trimming can be performed. Furthermore, by forming the trimming portion 4d in this manner, the length of the line in the resistor layer 4b can be increased, so that resistance can be increased.

Furthermore, as shown in FIG. 7E as well, the first linear oxidized portion 4d5 formed parallel to the width direction X2 and an L-shaped oxidized portion (L-oxidized portion) having a second linear oxidized portion 4d6 extending in the longitudinal direction X1 of the resistor layer 4b, that is formed by bending the first linear oxidized portion 4d5 substantially at a right angle at a certain point in the direction of laser light scanning may be provided. The length of the first linear oxidized portion 4d5 in the direction parallel to the width direction X2 of the resistor layer 4b is selected so as to be ½ or less of the length of the resistor layer 4b in the width direction X2. The length of the second linear oxidized portion 4d6 in the extending direction, in other words, the length of the second linear oxidized portion 4d6 in the direction parallel to the longitudinal direction X1 of the resistor layer 4b is selected so as to be longer than the length of the first linear oxidized portion 4d5 in the direction parallel to the width direction X2 of the resistor layer 4b.

In this case, the stress applied to the resistor layer 4b is reduced so that it becomes difficult that microcrack occur in the resistor layer 4b and thus drift caused by microcracks can be reduced.

Trimming can be performed with a sufficient adjustment width even with a single trimmable chip resistor 4. However, a plurality of trimmable chip resistors 4 that are connected in series or in parallel may be used.

The trimmable chip resistor 4 is provided so as to be exposed to the outside when incorporating the amplitude modulator into a high frequency transmitting/receiving apparatus. The trimmable chip resistor 4 is provided so as to be exposed to the outside when incorporating the selector switch into a high frequency transmitting/receiving apparatus. Thus, the resistance value of the trimmable chip resistor 4 can be changed in the state in which the amplitude modulator is incorporated or the when the selector switch is incorporated.

The amplitude modulator of the invention shown in FIGS. 1 to 4 operate in the same manner as the conventional amplitude modulator in the following manner. A high frequency signal, which is a signal to be modulated, that is input to the dielectric waveguides 1′ and 1″ (high frequency transmission line 1) for input is amplitude-modulated in the high frequency modulating portion M by a modulating signal output from the signal source 6, and the amplitude-modulated high frequency signal is output from the dielectric waveguides 2′ and 2″ (high frequency transmission line 2) for output. In this case, the transmission characteristics of the high frequency signal that is transmitted through the amplitude modulator (that is transmitted from the input terminal 1′a and 1″a of the dielectric waveguides 1′ and 1″ to the output terminal 2′a and 2″a of the dielectric waveguides 2′ and 2″) depend on the bias current flowing through the PIN diode 3. In the amplitude modulator of the invention, the trimmable chip resistor 4, which is a variable resistor, is provided between the signal source 6 and the PIN diode 3, so that by adjusting (trimming) the resistance value of the trimmable chip resistor 4, the bias current flowing through the PIN diode 3 can be adjusted and the transmission characteristics thereof can be adjusted (tuned) to the optimal state. For example, even after the amplitude modulator is incorporated into a module or the like, the characteristics of the modulator can be tuned in a simple manner with the trimmable chip resistor 4.

The selector switch of the invention shown in FIG. 5 operates such that a high frequency signal that is input to the input terminal 81a is transmitted through either one of the PIN diodes 3 and 3″ so as to be output from the one output terminal 82a or the other output terminal 83a. In this case, the transmission characteristics of the high frequency signal that is transmitted through the selector switch (that is transmitted from the input terminal 81a to the one output terminal 82a or from the input terminal 81a to the other output terminal 83a) depend on the bias current flowing through the PIN diode 3 or 3″. In the selector switch of the invention, the trimmable chip resistors 4 and 4″, which are variable resistors, are provided between the signal sources 6 and 6″ and the PIN diodes 3 and 3″, so that by adjusting (trimming) the resistance values of the trimmable chip resistors 4 and 4″, the bias current can be adjusted and the transmission characteristics thereof can be adjusted (tuned) to the optimal state as in the amplitude modulator shown in FIG. 1. For example, even after the selector switch is incorporated into a module or the like, the transmission characteristics of the selector switch can be tuned in a simple manner with the trimmable chip resistors 4 and 4″.

The same function of the trimmable chip resistor 4 can be obtained by using other variable resistors such as a trimmer resistor that is operated mechanically, for example, by rotation or with contact points, a potentiometer or a trimmer potentiometer, besides the trimmable chip resistor 4. However, an irreversible resistor such as the trimmable chip resistor 4 is preferable, and the trimmable chip resistor 4 is particularly preferable because even if vibration is applied to the trimmable chip resistor 4, the resistance value is not shifted or the reliability on temperature and humidity is high (the same applies to the trimmable chip resistor 4″).

Instead of the trimmable chip resistor 4, the trimmer potentiometer 104 may be used.

FIG. 8 is a perspective view showing the configuration of the trimmer potentiometer 104. The trimmer potentiometer 104 has lead wires 105 and a rotor 106. A lead wire 105a or a lead wire 105b is connected to the signal source 6, and a lead wire 105c is connected to a choke inductor 5. The trimmer potentiometer 104 can change the resistance value between the lead wires 105a, 105b and the lead wire 105c by engaging an engaging member in an engaging portion provided in the rotor 106 to rotate the rotor 106 around its axis. When the trimmer potentiometer 104 is used as a variable resistance, the trimmer potentiometer 104 functions so as to set the resistance value dynamically in accordance with the signal for control that is input from the outside, so that the trimmer potentiometer 104 can perform tuning so as to obtain a desired modulator characteristics against a change in the environmental conditions such as ambient temperatures or a temporal change in the characteristics of a high frequency modulating element. Therefore, the modulator characteristics can be further stabilized. As in the trimmable chip resistor 4, trimmer potentiometer 104 is preferable in that the trimmer potentiometer 104 has the characteristics that the resistance value can be set variably and the once set resistance value is unlikely to change unexpectedly (the same applies to the trimmable chip resistor 4″).

Instead of the PIN diode 3, other diodes such as Schottky barrier diodes or transistors such as field-effect transistors such as MESFETs and bipolar transistors may be used as the high frequency modulating element. However, it is preferable to use those that do not have a function of detecting a high frequency signal as a signal to be modulated, as the PIN diode 3 with respect to a high frequency signal in the millimeter band, because when modulating such a high frequency signal, even if the intensity of the high frequency signal that is input is changed, the bias current flowing through the high frequency modulating element is not changed thereby, and the transmission characteristics of the high frequency signal transmitted through the high frequency modulating element can be stabilized. As a result, even if the intensity of the high frequency signal that is input is changed, the modulator characteristics can be relatively stabilized.

Furthermore, instead of the PIN diodes 3 and 3″, other diodes such as Schottky barrier diodes or transistors such as field-effect transistors such as MESFETs (Metal Semiconductor Field Effect Transistors) and bipolar transistors may be used as the switching element. However, it is preferable to use those which do not have a function of detecting a high frequency signal, as the PIN diodes 3 and 3″ with respect to a high frequency signal in the millimeter band, because when switching such a high frequency signal, even if the intensity of the high frequency signal that is input is changed, the bias current flowing through the switching element is not changed thereby, and the transmission characteristics of the high frequency signal transmitted through the switching element can be stabilized. As a result, even if the intensity of the high frequency signal that is input is changed, the transmission characteristics of the selector switch can be relatively stabilized.

Furthermore, when a high frequency modulating element that does not have a function of detecting a high frequency signal as a signal to be modulated is used, it is preferable to form the island-shaped conductors 5′ e apart from the choke type bias supply line 5′ on the substrate 7 on both sides in the width direction thereof (or one side) for the following reason. A capacitance is formed between the island-shaped conductor 5′e and the line conductor 5d and the vicinity of the PIN diode 3, which is the high frequency modulating element of the choke type bias supply line, and this capacitance serves to confine the electric field of the high frequency signal so that the electric field of the high frequency signal is not leaked to the dielectric waveguide 2′ or the nonreflective terminator 10 side. Therefore, in the amplitude modulator shown in FIG. 1 and FIGS. 2A and 2B, the high frequency signal is hardly input to the dielectric waveguide 2′ side at the time of OFF, namelywhen the signal source 6 applies the voltage to the PIN diode 3 so as to be a reverse bias, so that the ON/OFF ratio of the amplitude modulator can be high. Furthermore, in the amplitude modulator shown in FIG. 4, the high frequency signal is hardly input to the nonreflective terminator 10 side at the time of ON, namely when the signal source 6 applies the voltage to the PIN diode 3 so as to be a forward bias, so that the output of the high frequency signal output from the dielectric waveguide 2″ at the time of ON can be large.

The amplitude modulator may be constituted as follows: the amplitude modulator having the above-described configuration and another similar amplitude modulator whose the input terminals 1a, 1′a and 1″ are connected to the output terminals 2a, 2′a and 2″a are included, and the resistance value of the trimmable chip resistor 4 as a variable resistor of the bias supply circuit provided with each of the amplitude modulators is different from each other. In this case, the frequency characteristics of the ON/OFF ratio is different between the amplitude modulators, so that the frequency bandwidth that can provide at least a predetermined ON/OFF ratio of the frequency characteristics can be enlarged by combining two different characteristics of different frequencies that provide a high ON/OFF ratio to obtain frequency characteristics having an ON/OFF ratio obtained by summing their ON/OFF ratios. Therefore, the frequency bandwidth that can provide a predetermined ON/OFF can be increased.

In the amplitude modulator of the invention, besides the nonradiative dielectric waveguide, a strip line, a microstrip line, a coplanar line, a coplanar line provided with a ground, a slot line, a wave guide, a dielectric wave guide, and the like may be used as the high frequency transmission line. However, it is preferable to use the nonradiative dielectric waveguide, a wave guide, a dielectric wave guide, and the like as the high frequency transmission line for the following reason. A circuit for transmitting a high frequency signal as a signal to be modulated and the bias circuit C for transmitting a modulating signal function substantially independently, so that the variable resistor provided in the bias circuit C functions with respect to the high frequency modulating element and hardly affects directly on the high frequency signal as a signal to be modulated. Therefore, tuning can be performed with good controllability in a simple configuration.

In the selector switch of the invention, besides the nonradiative dielectric waveguide, a strip line, a microstrip line, a coplanar line, a coplanar line provided with a ground, a slot line, a wave guide, a dielectric wave guide, and the like may be used as the high frequency transmission line. However, it is preferable to use the nonradiative dielectric waveguide, a wave guide, a dielectric wave guide, and the like as the high frequency transmission line for the following reason. A circuit for transmitting a high frequency signal as a signal to be modulated and the bias circuits C1 and C2 for transmitting a selector switch control signal function substantially independently, so that the variable resistors provided in the bias circuits C1 and C2 function with respect to the PIN diodes 3 and 3′ and hardly affect directly on the high frequency signal. Therefore, tuning can be performed with good controllability in a simple configuration.

Next, one example of a high frequency transmitting/receiving apparatus 110 according to a first embodiment of the invention, as shown in a block circuit diagram of FIG. 9, includes a high frequency oscillator 11 for generating high frequency signals; a branching device 12 that is connected to the high frequency oscillator 11 for branching the high frequency signal and outputting the signal to one output terminal 12b and the other output terminal 12c; an amplitude modulator 13 that is connected to the one output terminal 12b and is either one of the examples of the embodiment of the invention having the above-described configurations for modulating the high frequency signal that has been branched to the one output terminal 12b and outputting a high frequency signal for transmission; a circulator 14 that includes a first terminal 14a, a second terminal 14b and a third terminal 14c around a magnetic body, and outputs the high frequency signal that is input from one terminal from the next terminal adjacent in this order, the output of the amplitude modulator 13 being input to the first terminal 14a; an antenna 15 for transmission/reception connected to the second terminal 14b of the circulator 14; and mixer 16 connected between the other output terminal 12c of the branching device 12 and the third terminal 14c of the circulator 14 for mixing the high frequency signal branched to the other output terminal 12c and the high frequency signal received by the antenna 15 for transmission/reception and outputting an intermediate frequency signal.

In other words, the branching device 12 has two output portions 112b, 112c, and an input portion 112a is connected to the high frequency oscillator 11, so that the high frequency signal supplied from the high frequency oscillator 11 is branched and output from one output portion 112b and another output portion 112c. When the amplitude modulator shown in FIG. 1 is used, the input terminal 13a is connected to the one output portion 112b, and the first terminal 14a of the circulator 14,which is a signal divider, is connected to the output terminal 13b. When the amplitude modulator shown in FIG. 2 is used, the input terminal 1″a is connected to the one output portion 112b, and the first terminal 14a of the circulator 14, which is a signal divider, is connected to the output terminal 2″a.

The amplitude modulator 13 modulates the high frequency signal branched by this one output portion 112b and outputs a high frequency signal for transmission. When the circulator 14, which is a signal divider, receives the high frequency signal for transmission from the modulator 13 at its first terminal 14a, the high frequency signal for transmission input from the first terminal 14a is output from the second terminal 14b, and the high frequency signal for transmission input from the second terminal 14b is output from the third terminal 14c. In the mixer 16, its first input terminal 16a is connected to the other output portion 112c of the branching device 12, and its second input terminal 16b is connected to the third terminal 14c, and thus the branched high frequency signal that is output from the other output portion 112c is mixed with a high frequency signal received at the antenna 15 for transmission/reception so that an intermediate signal is output.

The high frequency transmitting/receiving apparatus 110 according to the first embodiment of the invention shown in FIG. 9 uses a nonradiative dielectric waveguide as the high frequency transmission line for connecting the components as described above. The basic configuration of the nonradiative dielectric waveguide is the same as that shown by the partially cut perspective view of FIG. 18.

More specifically, as shown in a plan view of FIG. 10, the high frequency transmitting/receiving apparatus 110 according to the first embodiment of the invention shown in FIG. 9 includes, between plate conductors 21 (the other plate conductor is not shown) that are arranged in parallel with a gap of ½ or less of the wavelength of a high frequency signal, a high frequency oscillator 11, to which one end of a first dielectric waveguide 22 is connected, for frequency-modulating a high frequency signal output from the high frequency diode and letting the high frequency signal propagate the first dielectric waveguide 22 and outputting the high frequency signal; an amplitude modulator 13 that is connected to the other end of the first dielectric waveguide 22 and is either one of the examples of the embodiment of the invention having the above-described configurations for reflecting the high frequency signal to the input terminal 13a side or transmitting the high frequency signal to the output terminal 13b side, depending on the pulse signal; a second dielectric waveguide 23 whose one end is connected to the output terminal 13b of the amplitude modulator 13; a circulator 14 that includes a first terminal 24a, a second terminal 24b and a third terminal 24c, which are each an input/output terminal of the high frequency signal, in the peripheral portion of a ferrite plate 24 provided in parallel with the plate conductors 21, and outputs the high frequency signal that is input from one terminal from the next terminal adjacent in this order, the first terminal 24a being connected to the other end of the second dielectric waveguide 23; a third dielectric waveguide 25 and a fourth dielectric waveguide 26 that are provided radially in the peripheral portion of the ferrite plate 24 of the circulator 14 and whose ends are connected to the second terminal 24b and the third terminal 24c, respectively; an antenna 15 for transmission/reception connected to the other terminal of the third dielectric waveguide 25; a fifth dielectric waveguide 27 whose middle point is positioned close or joined to a middle point of the first dielectric waveguide 22, that is, whose intermediate portion in the extending direction of the line is positioned close or joined to an intermediate portion in the extending direction of the first dielectric waveguide 22, for branching a part of the high frequency signal propagated on the first dielectric waveguide 22 and propagating the high frequency signal; a nonreflective terminator 28 connected to one end of the fifth dielectric waveguide 27 on the high frequency oscillator 11 side; and a mixer 16 connected between the other end of the fourth dielectric waveguide 26 and the other end of the fifth dielectric waveguide 27 for mixing the high frequency signal input from the fifth dielectric waveguide 27 and the high frequency signal received by the antenna 15 for transmission/reception and input from the circulator 14 and outputting an intermediate frequency signal. In this configuration, the portion in which the first dielectric waveguide 22 and the fifth dielectric waveguide 27 are positioned close or are joined constitutes the branching device 12.

In FIG. 10, the first terminal 24a, the second terminal 24b and the third terminal 24c correspond to the first terminal 14a, the second terminal 14b and the third terminal 14c in FIG. 9.

In this configuration, in the mixer 16, as shown in a perspective view of FIG. 11, a high frequency detecting portion is such that a diode 43 as a high frequency modulating element is connected to a connection terminal 42 formed in a portion where the choke type bias supply line 41 formed on one surface in the thickness direction of the substrate 40 is interrupted. This high frequency signal detecting portion is provided in the other end of the fourth dielectric waveguide 26 and the other end of the fifth dielectric waveguide 27 such that the high frequency signals output from the fourth dielectric waveguide 26 and the fifth dielectric waveguide 27 enter the diode 43. The choke type bias supply line 41 has the same shape as that of the choke type bias supply line 5′ shown in FIG. 3 described above. In FIG. 11, for clarification, the choke type bias supply line 41 is hatched. In this configuration, for the diode 43 as a high frequency detecting element, a Schottky barrier diode can be used.

The high frequency transmitting/receiving apparatus 110 according to the first embodiment of the invention shown in FIGS. 9 and 10 that is configured as above operates in the same manner as a conventional high frequency transmitting/receiving apparatus. However, since the amplitude modulator of the invention is provided as the amplitude modulator 13, the amplitude modulator 13 serves to tune the modulator characteristics in accordance with the characteristics of the PIN diode 3 or its mounting state, resulting in a high performance high frequency transmitting/receiving apparatus in which good transmission output can be obtained stably. Furthermore, the trimmable chip resistor can hold a predetermined resistance value stably under an environment in which vibration or temperature changes are extreme, and therefore, even in such an environment, good modulator characteristics can be maintained. Therefore stable performance can be obtained constantly.

In the above configuration, it is possible that a potentiometer or a trimmer potentiometer is used as the variable resistor connected as a component of the bias circuit C of the amplitude modulator 13, and that a part of a detected output that has been detected by the high frequency detecting portion of the mixer 16 on the other output terminal 12c side (the fifth dielectric waveguide 27 side) is input as a control signal to the control terminal for controlling the resistance value of the potentiometer or the trimmer potentiometer. In this case, the resistance value of the potentiometer or the trimmer potentiometer may be set during the time when the high frequency detecting portion of the mixer 16 is detecting almost only the high frequency signals output from the other output terminal 12c of the branching device 12. With this configuration, the intensity of the high frequency signal output from the high frequency oscillator 11 is monitored, so that a high frequency signal for transmission that has been adjusted to a desired output intensity can be output from the amplitude modulator 13 in accordance with the variation in the intensity.

Furthermore, in the above configuration, preferably, a switch 17 for switching in accordance with a switching control signal from the outside maybeprovided at an output terminal of the mixer 16. When the switch 17 for switching in accordance with a switching control signal from the outside is provided at an output terminal of the mixer 16, that is, the output portion 16c from which a generated intermediate frequency signal is output, even if a part of a high frequency signal for transmission is leaked to the third terminal 14c of the circulator 14 because of insufficient isolation between the first terminal 14a and the third terminal 14c of the circulator 14, the switch 17 can be operated to block an intermediate frequency signal with respect to the leaked high frequency signal so that such an intermediate frequency signal is not output. This makes it easy to identify a high frequency signal to be received on the receiving side.

Next, a high frequency transmitting/receiving apparatus 120 according to a second embodiment of the invention, as shown in a block circuit diagram of FIG. 12, includes a high frequency oscillator 11 for generating high frequency signals; a branching device 12 that is connected to the high frequency oscillator 11 for branching the high frequency signal and outputting the signal to one output terminal 12b and the other output terminal 12c; an amplitude modulator 13 that is connected to the one output terminal 12b and is either one of the examples of the embodiment of the invention having the above-described configurations for modulating the high frequency signal that has been branched to the one output terminal 12b and outputting a high frequency signal for transmission; an isolator 18 whose input terminal 18a is connected to the output terminal 13b of the amplitude modulator 13 for transmitting a high frequency signal for transmission to the output terminal 18b from the input terminal 18a; an antenna 19 for transmission connected to the isolator 18; an antenna 20 for reception connected to the other output terminal 12c of the branching device 12; and mixer 16 whose two input terminals 16a, 16b are connected to the other output terminal 12c of the branching device 12 and the antenna 20 for reception, respectively, for mixing the high frequency signal branched to the other output terminal 12c and the high frequency signal received by the antenna 20 for reception and outputting an intermediate frequency signal. In the high frequency transmitting/receiving apparatus 120, the same components as in the previous embodiment bears the same reference numeral and description thereof may be omitted.

The high frequency transmitting/receiving apparatus 120 according to the second embodiment of the invention shown in FIG. 12 uses a nonradiative dielectric waveguide as the high frequency transmission line for connecting the components as described above. The basic configuration of this nonradiative dielectric waveguide is the same as that shown by the partially cut perspective view of FIG. 15.

More specifically, as shown in a plan view of FIG. 13, the high frequency transmitting/receiving apparatus 120 according to the second embodiment of the invention shown in FIG. 12 includes, between plate conductors 31 (the other plate conductor is not shown) that are arranged in parallel with a gap of ½ or less of the wavelength of a high frequency signal, a high frequency oscillator 11, to which one end of a first dielectric waveguide 32 is connected, for frequency-modulating a high frequency signal output from the high frequency diode and letting the high frequency signal propagate the first dielectric waveguide 32 and outputting the high frequency signal; an amplitude modulator 13 that is connected to the other end of the first dielectric waveguide 32 and is either one of the examples of the embodiment of the invention having the above-described configurations for reflecting the high frequency signal to the input terminal 13a side or transmitting the high frequency signal to the output terminal 13b side, depending on the pulse signal; a second dielectric waveguide 33 whose one end is connected to the output terminal 13b of the amplitude modulator 13; a circulator 1 that includes a first terminal 34a, a second terminal 34b and a third terminal 34c, which are each an input/output terminal of the high frequency signal, in the peripheral portion of a ferrite plate 34 provided in parallel with the plate conductors 31, and outputs the high frequency signal that is input fromone terminal from the next terminal adjacent in this order, the first terminal 34a being connected to the other end of the second dielectric waveguide 33; a third dielectric waveguide 35 and a fourth dielectric waveguide 36 that are provided radially in the peripheral portion of the ferrite plate 34 of the circulator 1 and whose ends are connected to the second terminal 34b and the third terminal 34c, respectively; an antenna 19 for transmission connected to the other end of the third dielectric waveguide 35; a fifth dielectric waveguide 37 whose middle point is positioned close or joined to a middle point of the first dielectric waveguide 32, for branching a part of the high frequency signal propagated on the first dielectric waveguide 32 and propagating the high frequency signal; a nonreflective terminator 38a connected to the other end of the fourth dielectric waveguide 36; a nonreflective terminator 38b connected to one end of the fifth dielectric waveguide 37 on the high frequency oscillator 11 side; a sixth dielectric waveguide 39 whose one end is connected to the antenna 20 for reception; and a mixer 16 connected between the other end of the fifth dielectric waveguide 37 and the other end of the sixth dielectric waveguide 39 for mixing the high frequency signal input from the fifth dielectric waveguide 37 and the high frequency signal received by the antenna 20 for reception and input from the sixth dielectric waveguide 39 and outputting an intermediate frequency signal. In this configuration, the portion in which the first dielectric waveguide 32 and the fifth dielectric waveguide 37 are positioned Close or are joined constitutes the branching device 12. The isolator 18 is constituted by including circulator 14, the fourth dielectric waveguide 36, and the nonreflective terminator 38a.

In FIG. 13, the first terminal 34a, the second terminal 34b and the third terminal 34c correspond to the input terminal 18a, the input terminal 18b and the input terminal 18c in FIG.12.

In this configuration, in the mixer 16, as shown in a perspective view of FIG. 11, a high frequency detecting portion is such that a diode 43 as a high frequency modulating element is connected to a connection terminal 42 formed in a portion where the choke type bias supply line 41 formed on one surface in the thickness direction of the substrate 40 is interrupted. This high frequency signal detecting portion is provided in the other end of the fifth dielectric waveguide 27 and the other end of the sixth dielectric waveguide 39 such that the high frequency signals output from the fifth dielectric waveguide 27 and the sixth dielectric waveguide 39 enter the diode 43. In this configuration, for the diode 43 as a high frequency detecting element, a Schottky barrier diode can be used.

The high frequency transmitting/receiving apparatus 120 according to the second embodiment of the invention shown in FIGS. 12 and 13 that is configured as above operates in the same manner as a conventional high frequency transmitting/receiving apparatus. However, since the amplitude modulator of the invention is provided as the amplitude modulator 13, the amplitude modulator 13 serves to tune the modulator characteristics in accordance with the characteristics of the PIN diode 3 or its mounting state, resulting in a high performance high frequency transmitting/receiving apparatus in which good transmission output can be obtained stably. Furthermore, the trimmable chip resistor can hold a predetermined resistance value stably under an environment in which vibration or temperature changes are extreme, and therefore, even in such an environment, good modulator characteristics can be maintained. Therefore stable performance can be obtained constantly.

In the above configuration, it is possible that a potentiometer or a trimmer potentiometer is used as the variable resistor connected as a component of the bias circuit C of the amplitude modulator 13, and that a part of a detected output that has been detected by the high frequency detecting portion of the mixer 16 on the other output terminal 12c side (the fifth dielectric waveguide 37 side) is input as a control signal to the control terminal for controlling the resistance value of the potentiometer or the trimmer potentiometer. In this case, the resistance value of the potentiometer or the trimmer potentiometer may be set during the time when the high frequency detecting portion of the mixer 16 is detecting almost only the high frequency signals output from the other output terminal 12c of the branching device 12. With this configuration, the intensity of the high frequency signal output from the high frequency oscillator 11 is monitored, so that a high frequency signal for transmission that has been adjusted to a desired output intensity can be output from the amplitude modulator 13 in accordance with the variation in the intensity.

Furthermore, in the above configuration, preferably, a switch 17 for switching in accordance with a switching control signal from the outside may be provided at an output terminal of the mixer 16. When the switch 17 for switching in accordance with a switching control signal from the outside is provided at an output terminal of the mixer 16, that is, the output portion 16c from which a generated intermediate frequency signal is output, even if a part of a high frequency signal for transmission is leaked to the antenna 20 for reception because of insufficient isolation between the antenna 19 for transmission and the antenna 20 for reception, the switch 17 can be operated to block an intermediate frequency signal with respect to the leaked high frequency signal so that such an intermediate frequency signal is not output. This makes it easy to identify a high frequency signal to be received on the receiving side.

Next, a high frequency transmitting/receiving apparatus 130 according to a third embodiment of the invention shown in FIG. 14 includes a high frequency oscillator 11 for generating high frequency signals; the selector switch 71 according to one embodiment of the invention having the above configuration, whose input terminal 71a is connected to the high frequency oscillator 11, for switching a high frequency signal so that,either a high frequency signal RFt for transmission is output to the one output terminal 71b or a local signal L0 is output to the other output terminal 71c; a second selector switch 72 having an input terminal 72b, an output terminal 72c and an input/output terminal 72a, whose input terminal 72b is connected to the one output terminal 71b, for switching the input/output terminal 72a to the input terminal 72b or the output terminal 72c for connection; an antenna 15 for transmission connected to the input/output terminal 72a of the second selector switch 72; and a mixer 16 connected between the other output terminal 71c of the selector switch 71 and the terminal 72c of the second selector switch 72 for mixing the local signal L0 output to the other output terminal 71c and the high frequency signal received by the antenna 15 for transmission/reception and outputting an intermediate frequency signal. In the high frequency transmitting/receiving apparatus 130 according to the third embodiment of the invention, the same components as in the previous embodiments bear the same reference numerals and description thereof may be omitted.

The second selector switch 72, which is a signal divider, has a first terminal 172b in which the input terminal 72b is formed, a second terminal 172a in which the input/output terminal 72a is formed and a third terminal 172c in which the output terminal 72c is formed. The second selector switch 72 switches the connection state between the first terminal 172b, the second terminal 172a and the third terminal 172c, so that a high frequency signal for transmission is supplied from the selector switch 71 to the first terminal 172a, and the high frequency signal input from the first terminal 172b is output to the second terminal 172a, and the high frequency signal input from the second terminal 172a is output to the third terminal 172c. The mixer 16 is connected to the other output terminal 71c of the selector switch 71 and the third terminal 172c of the second selector switch 72.

When outputting a high frequency signal for transmission from the antenna 15 for transmission/reception, a control signal from the outside is supplied to the selector switch 71 and the second selector switch 72 so that in the selector switch 71, the high frequency signal supplied to the input terminal 71a is output from the one output terminal 71b, and that in the second selector switch 72, the high frequency signal supplied to the first terminal 172b is supplied to the second terminal 172a. When receiving a high frequency signal by the antenna 15 for transmission/reception, a control signal from the outside is supplied to the selector switch 71 and the second selector switch 72 so that in the selector switch 71, the high frequency signal supplied to the input terminal 71a is output from the other output terminal 71c, and that in the second selector switch 72, the high frequency signal supplied to the second terminal 172a is supplied to the third terminal 172c.

The input terminal 71a, the one output terminal 71b, and the other output terminal 71c in FIG. 14 correspond to the input terminal 81a, the one output terminal 82a, and the other output terminal 83a in FIG. 5.

Next, a high frequency transmitting/receiving apparatus 140 according to a fourth embodiment of the invention shown in FIG. 15 includes a high frequency oscillator 11 for generating high frequency signals; the selector switch 71 of an embodiment of the invention having the above configuration whose input terminal 71a is connected to the high frequency oscillator 11, for switching a high frequency signal so that either a high frequency signal RFt for transmission is output to the one output terminal 71b or a local signal L0 is output to the other output terminal 71c; an antenna 19 for transmission connected to the one output terminal 71b; an antenna 20 for reception connected to the other output terminal 71c side of the selector switch 71; and a mixer 16 connected between the other output terminal 71c of the selector switch 71 and the antenna 20 for reception for mixing the local signal L0 output to the other output terminal 71c and the high frequency signal received by the antenna 20 for reception and outputting an intermediate frequency signal. In the high frequency transmitting/receiving apparatus 140, the same components as in the previous embodiments bear the same reference numerals and description thereof may be omitted.

When outputting a high frequency signal for transmission from the antenna 19 for transmission, a control signal from the outside is supplied to the splector switch 71 so that in the selector switch 71, the high frequency signal supplied to the input terminal 71a is output from the one output terminal 71b. When receiving a high frequency signal by the antenna 20 for reception, a control signal from the outside is supplied to the selector switch 71 so that in the selector switch 71, the high frequency signal supplied to the input terminal 71a is output from the other output terminal 71c.

The high frequency transmitting/receiving apparatuses 130 and 140 according to the third and fourth embodiments of the invention shown in FIGS. 14 and 15 also can use a nonradiative dielectric waveguide as the high frequency transmission line for connecting the components as described above. The basic configuration of the nonradiative dielectric waveguide is the same as that shown by the partially cut perspective view of FIG. 18.

According to the high frequency transmitting/receiving apparatuses 130 and 140 according to the third and fourth embodiments of the invention shown in FIGS. 14 and 15, since the selector switch of the invention is provided as the selector switch 71, the selector switch 71 serves to tune the transmission characteristics of the selector switch in accordance with the characteristics of the PIN diodes 3 and 3″ or their mounting state, resulting in a high performance high frequency transmitting/receiving apparatus in which good transmission output can be obtained stably. Furthermore, trimmable chip resistor can hold a predetermined resistance value stably under an environment vibration or temperature changes are extreme, and therefore, even in such an environment, good modulator characteristics can be maintained. Therefore stable performance can be obtained constantly.

In the above configuration, it is possible that a potentiometer or a trimmer potentiometer is used as the variable resistor connected as a component of the bias circuits C1 and C2 of the selector switch 71, and that a part of a detected output that has been detected by the high frequency detecting portion of the mixer 16 on the other output terminal 71c side is input as a control signal to the control terminal for controlling the resistance value of the potentiometer or the trimmer potentiometer. In this case, the resistance value of the potentiometer or the trimmer potentiometer may be set during the time when the high frequency detecting portion of the mixer 16 is detecting almost only the high frequency signals output from the other output terminal 71c of the selector switch 71. With this configuration, the intensity of the high frequency signal output from the high frequency oscillator 11 is monitored, so that a high frequency signal RFt for transmission that is adjusted to a desired output intensity can be output from the selector switch 71 in accordance with the variation in the intensity.

Also in the high frequency transmitting/receiving apparatuses 130 and 140 according to the third and fourth embodiments of the invention, as shown in FIGS. 14 and 15, a switch 17 constituted by a semiconductor such as CMOS (complementary metal oxide semiconductor) that blocks intermediate frequency signals in response to a control signal from the outside may be connected to the output terminal of the mixer 16. In this case, the switch 17 operates so as to block an unwanted intermediate frequency signals corresponding toa high frequency signal that is transmitted between the first terminal 172b of the second selector switch 72 and the third terminal 172c or between the antenna 19 for transmission and the antenna 20 for reception, leaked and input to the mixer 16, so that unwanted noise is not mixed to an intermediate frequency signal to be received, and therefore the receiving performance can be improved.

Next, in the high frequency transmitting/receiving apparatus of the invention, the first to the sixth dielectric waveguides 22, 23, 25 to 27, 32, 33, 35 to 37 and 39 are preferably made of, for example, resins such as tetrafluoroethylene and polystyrene, or ceramics such as cordierite (2MgO-2Al₂O₃-5SiO₂) ceramics having a low dielectric, alumina (Al₂O₃) ceramics and glass ceramics, and these materials provide low loss in high frequency signals in the millimeter wave band.

The cross-sectional shape of the first to the sixth dielectric waveguides 22, 23, 25 to 27, 32, 33, 35 to 37 and 39 in one virtual plane that is perpendicular to the extending direction is basically substantially rectangular, but may be rounded at the corners of a rectangle, and various cross-sectional shapes used for transfer of high frequency signals can be used.

As the material for the ferrite plates 24 and 34, among ferrite, zinc nickel iron oxide (ZnₐNi_{b}Fe_{c}Oₓ) is preferable to high frequency signals.

Furthermore, the shape of the ferrite plates 24 and 34 is, in general, circular, but besides that, the shape viewed from the top may be regular polygonal, in other words, the shape viewed from one side in the thickness direction may be regular polygonal. In this case, taking the number of dielectric waveguides to be connected as n (n is an integer of 3 or more), it is preferable that the shape viewed from the top is regular polygonal having m sides (m is an integer of 3 or more and larger than n).

As the material for the plate conductors 21 and 31 and the other plate conductors that are not shown in the drawings, conductor plates of Cu, Al, Fe, Ag, Au, Pt, SUS (stainless steel) and brass (Cu—Zn alloy) are preferable because of high electrical conductivity, good processibility and the like. Alternatively, layers of these conductors formed on a surface of an insulating plate made of ceramics, resin and the like may be used.

The nonreflective terminators 28, 38a and 38b can be constituted by allowing a film-like resistor or wave absorber to adhere onto an internal surface of the dielectric waveguide 53 that is parallel to the plate conductors 51 and 52 with respect to such a dielectric waveguide 53 as shown in FIG. 18, for example. In this case, as the material of the resistor, nickel chrome alloys, carbons and the like are preferable. As the material of the wave absorber, permalloy, sendust and the like are preferable. With these materials, millimeter wave signals can be attenuated efficiently. Any other materials that can attenuate millimeter wave signals can be used.

For the substrates 7 and 40, a substrate obtained by forming a choke type bias supply lines 5′ and 41 made of a strip conductor or the like formed of aluminum (Al), gold (Au) , copper (Cu) or the like on one principal surface of a plate-like substrate made of tetrafluoroethylene, polystyrene, glass ceramics, glass epoxy resin, epoxy resin, thermoplastic resins or the like, such as so-called liquid crystal polymer or the like can be used.

The high frequency transmitting/receiving apparatus of the invention is characterized in that at least one of the amplitude modulator and the selector switch of the invention is provided, and as the high frequency transmission line connecting between the circuit elements, besides the nonradiative dielectric waveguide, a wave guide, a dielectric wave guide, a strip line, a microstrip line, a coplanar line, a slot line, a coaxial line, high frequency transmission lines obtained by transforming these lines may be selected in accordance with the frequency band to be used or the applications. The frequency band to be used is effective, not only for the millimeter wave band, but also for the microwave band or smaller frequency band.

Instead of the circular 14, a duplexer, a switch, a hybrid circuit and the like may be used. For the high frequency oscillator, the modulator and the mixer, bipolar transistors, field effect transistors (FETs) and integrated circuits (CMOS, MMIC, etc.) which integrate these above, and the like can be used, instead of diodes.

Next, a radar apparatus of the invention, and a radar apparatus-mounting vehicle and a radar apparatus-mounting small boat on which a radar apparatus is mounted will be described.

One example of an embodiment of the radar apparatus of the invention has a configuration including either one of the high frequency transmitting/receiving apparatuses 110, 120, 130, and 140 according to the first to the fourth embodiments of the invention and a distance information detecting device for detecting in formation on the distance up to an object to be detected by processing an intermediate frequency signal output from the high frequency transmitting/receiving apparatuses 110, 120, 130, and 140.

The radar apparatus of the invention has the configuration as above, and therefore the high frequency transmitting/receiving apparatus of the invention transmits high frequency signals for transmission stably at good transmission output, so that a radar apparatus that can detect an object to be detected fast and reliably and detect an object to be detected that is near or far away fast and reliably can be obtained. Furthermore, with the high frequency transmitting/receiving apparatus of the invention that provides stable performance, even in an environment in which vibration, temperature changes or the like are extreme, a radar apparatus that operates reliably under such extreme conditions can be obtained.

The radar apparatus-mounting vehicle of the invention has a configuration that includes the radar apparatus of the invention and in which the radar apparatus is used to detect an object to be detected.

The radar apparatus-mounting vehicle of the invention has such a configuration, so that similarly to a conventional radar apparatus-mounting vehicle, the behavior of the vehicle can be controlled based on the distance information detected by the radar apparatus, or the driver can be warned of, for example, an obstacle on a street or other vehicles, with sound, light or vibration. However, in the radar apparatus-mounting vehicle of the invention, an obstacle on a street or other vehicles can be detected fast and reliably so that appropriate control of the vehicle and appropriate warning to the driver can be performed without causing the vehicle to perform a sudden action.

The radar apparatus-mounting vehicle of the invention can be used, to be specific, in not only vehicles for transporting passengers or cargo such as railway trains, electric trains, and automobiles, but also bicycles, motor bicycles, and rides in an amusement park and carts in golf links.

The radar apparatus-mounting small ship of the invention has a configuration that includes the radar apparatus of the invention and in which the radar apparatus is used to detect an object to be detected.

The radar apparatus-mounting small ship of the invention has such a configuration, so that similarly to a conventional radar apparatus-mounting vehicle, in the small ship, the behavior of the small ship can be controlled based on the distance information detected by the radar apparatus, or the operator can be warned of, for example, obstacles such as a reef, other vessels or other small boats, with sound, light or vibration. However, in the radar apparatus-mounting small ship of the invention, obstacles such as a reef, other vessels or other small boats can be detected fast and reliably so that appropriate control of the small ship and appropriate warning to the operator can be performed without causing the small ship to perform a sudden action.

The radar apparatus-mounting small boat of the invention is, to be specific, a boat that can be operated with or without a license of a small vessel, and can be used in a hand-worked fishing boat, dinghy, water motorbike, small bus-boat with an outboard motor, inflatable boat(rubber boat) with an outboard motor, fishing vessel, pleasure and fishing boat, work boat, barge, towing boat, sports boat, fishing boat, yacht, offshore yacht, cruiser, and pleasure boat with a gross tonnage of 20 tons or more.

Next, the transmission characteristics of a high frequency signal in the amplitude modulator shown in FIG. 1 and the selector switch shown in shown in FIG. 5 will be described, Table 1 shows the results of experiments in which the attenuation amount of the high frequency signal was measured when the resistance value of the trimmable chip resistor 4 was changed in the amplitude modulator shown in FIG. 1 and the selector switch shown in FIG. 5.

TABLE 1

| | | Diode | | Trimmable | Trimmable | |
|---|---|---|---|---|---|---|
| | Diode | direct | Bias | resistance | resistance | |
| Id | applied | current | Voltage | voltage | value | Attenuation |
| (mA) | Vd (V) | R (Ω) | (V) | Vr (V) | Rr (Ω) | amount (dB) |
| 0.0 | 0.00 | — | 5 | 5.00 | — | 16.25 |
| 0.2 | 1.14 | 5700 | 5 | 3.86 | 19300 | 4.83 |
| 0.4 | 1.17 | 2925 | 5 | 3.83 | 9575 | 2.95 |
| 0.7 | 1.20 | 1714 | 5 | 3.80 | 5429 | 1.88 |
| 1.0 | 1.22 | 1220 | 5 | 3.78 | 3780 | 1.37 |
| 1.5 | 1.24 | 827 | 5 | 3.76 | 2507 | 0.93 |
| 2.0 | 1.25 | 625 | 5 | 3.75 | 1875 | 0.69 |
| 3.0 | 1.27 | 423 | 5 | 3.73 | 1243 | 0.44 |
| 4.0 | 1.28 | 320 | 5 | 3.72 | 930 | 0.30 |
| 6.0 | 1.30 | 217 | 5 | 3.70 | 617 | 0.16 |
| 8.0 | 1.31 | 164 | 5 | 3.69 | 461 | 0.08 |
| 10.0 | 1.32 | 132 | 5 | 3.68 | 366 | 0.05 |
| 12.0 | 1.33 | 111 | 5 | 3.67 | 306 | 0.00 |

In Table 1, Id (unit: mA) refers to the bias current flowing through the PIN diode 3; diode applied Vd (unit: V) refers to the bias voltage applied to the PIN diode 3; diode direct current R (unit: Ω) refers to the direct current resistance of the PIN diode 3; the bias voltage (unit: V) refers to the voltage supplied from the signal source 6; the trimmable resistance voltage Vr (unit: V) refers to the voltage applied to the trimmable chip resistor 4; the trimmable resistance value Rr (unit: Ω) refers to the resistance value of the trimmable chip resistor 4; and the attenuation amount (unit: dB) refers to the attenuation amount of the high frequency signal output from the output terminal with respect to the high frequency signal input from the input terminal.

FIG. 16 is a graph showing the relationship between the bias voltage applied to the PIN diode 3 shown in Table 1 and the bias current. In FIG. 16, the horizontal axis shows the bias voltage (unit: V), and the vertical axis shows the bias current (unit: A). When a voltage is applied to the PIN diode 3 so as to be a forward direction bias, current does not flow until a predetermined voltage, in this embodiment, until about 1.14 V, but when exceeding this predetermined voltage, current flows rapidly.

FIG. 17 is a graph showing the relationship between the resistance value of the trimmable chip resistor 4 shown in Table 1 and the attenuation amount of the high frequency signal. In FIG. 17, the horizontal axis shows the resistance value (unit: Ω) of the trimmable chip resistor 4, and the vertical axis shows the attenuation amount of the high frequency signal. The resistance value of the trimmable chip resistor 4 is referred to as “trimmable resistance value”. In the amplitude modulator and the selector switch, when the trimmable resistance value increases, the attenuation amount of the high frequency signal increases. That is to say, the amplitude of the high frequency signal can be reduced by increasing the trimmable resistance value in the amplitude modulator. The trimmable chip resistor 4 is an irreversible resistor, so that when adjusting the amplitude of the high frequency signal, the current flowing through the PIN diode 3 is changed to one direction, that is, reduced in this embodiment.

Thus, according to the invention, an amplitude modulator can be provided in which the bias supply circuit of a high frequency modulating element, which is a component of the amplitude modulator, is provided with a variable resistor, and with this variable resistor, the modulator characteristics can be tuned in a simple manner. Furthermore, a high performance high frequency transmitting/receiving apparatus that can stabilize the high frequency signal for transmission with a predetermined output intensity in a simple configuration can be provided by including at least either one of the amplitude modulator and the selector switch, and a radar apparatus provided with such a high performance high frequency transmitting/receiving apparatus and a radar apparatus-mounting vehicle and radar apparatus-mounting small boat that are provided with such a radar apparatus can be provided.

The present invention is not limited to the examples of the embodiments described above, and can be modified to various other forms in the scope of the gist of the invention. For example, as the variable resistor, an element in which a contact point of a fixed resistor network in which a plurality of fixed resistors are connected is switched with a relay can be used. In this case, it is possible that the resistance value of the fixed resistor network can be set dynamically, and for example, the fixed resistor network is synchronized with the operation of the amplitude modulator 13 so that the operation of the amplitude modulator 13 becomes appropriate against changes of ambient conditions, so that the bias current of the amplitude modulator 13 is dynamically changed.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An amplitude modulator comprising:
two high frequency transmission lines for transmitting high frequency signals;
a high frequency modulating element that is provided between the high frequency transmission lines and that modulates a high frequency signal input from one of the high frequency transmission lines and outputs the high frequency signal to the other of the high frequency transmission lines; and
a bias supply circuit that is connected to tie high frequency modulating element and supplies a bias voltage to the high frequency modulating element,
wherein the bias supply circuit includes a variable resistor for adjusting a bias current flowing through the high frequency modulating element.

2. The amplitude modulator of claim 1, wherein the variable resistor is constituted by a trimmable chip resistor.

3. The amplitude modulator of claim 1, wherein the variable resistor is constituted by a trimmer potentiometer.

4. The amplitude modulator of claim 1, wherein the high frequency modulating element is constituted by a PIN diode.

5. A selector switch comprising:
an input side high frequency transmission line having an input terminal;
two output side high frequency transmission lines each having an output terminal;
PIN diodes, one of which is provided between the input side high frequency transmission line and one of the output side high frequency transmission lines, and another of which is provided between the input side high frequency transmission line and the other of the output side high frequency transmission lines; and
a bias supply circuit provided so as to individually correspond to each of the PIN diodes, for supplying a bias voltage to the PIN diodes,
wherein the bias supply circuit includes a variable resistor for adjusting a bias current flowing through the PIN diodes.

6. The selector switch of claim 5, wherein the variable resistor is constituted by a trimmable chip resistor.

7. A high frequency transmitting/receiving apparatus comprising:
a high frequency oscillator for generating a high frequency signal;
a branching device having two output portions and connected to the high frequency oscillator, for branching the high frequency signal supplied from the high frequency oscillator and outputting signals from one of the two output portions and the other of the two output portions;
the amplitude modulator of claim 1 in which the one of the high frequency transmission lines is connected to the one output portion of the branching device, for modulating a high frequency signal branched to the one output portion and outputting a high frequency signal for transmission from the other high frequency transmission line;
a signal divider having a first terminal, a second terminal and a third terminal, the other of the high frequency transmission lines of the amplitude modulator being connected to the first terminal, the high frequency signal for transmission input from the first terminal being output from the second terminal, the high frequency signal input from the second terminal being output from the third terminal;
an antenna for transmission/reception that is connected to the second terminal; and
a mixer that is connected between the other output portion of the branching device and the third terminal, for mixing the high frequency signal that is branched and output from the other output portion and a high frequency signal received at the antenna for transmission/reception and outputting an intermediate frequency signal.

8. A high frequency transmitting/receiving apparatus comprising:
a high frequency oscillator for generating a high frequency signal;
a branching device having two output portions and connected to the high frequency oscillator, for branching the high frequency signal supplied from the high frequency oscillator and outputting signals from one of the two output portions and the other of the two output portions;
the amplitude modulator of claim 1 in which the one of the high frequency transmission lines is connected to the one output portion of the branching device, for modulating a high frequency signal branched to the one output portion and outputting a high frequency signal for transmission from the other high frequency transmission line;
an isolator having an input terminal and an output terminal, for, when supplied with a high frequency signal for transmission at the input terminal from the amplitude modulator, outputting the high frequency signal for transmission from the output terminal;
an antenna for transmission that is connected to the output terminal;
an antenna for reception; and
a mixer that is connected to the other output portion of the branching device and the antenna for reception, for mixing the high frequency signal that is branched and output from the other output portion and a high frequency signal received at the antenna for reception and outputting an intermediate frequency signal.

9. A high frequency transmitting/receiving apparatus comprising:
a high frequency oscillator for generating:a high frequency signal;
the selector switch of claim 5, whose input terminal is connected to the high frequency oscillator, for selectively outputting the high frequency signal supplied from the high frequency oscillator, from the one and the other output side high frequency transmission line;
a signal divider having a first terminal, a second terminal and a third terminal, an output terminal of the one of the output side high frequency signal transmission lines of the selector switch being connected to the first terminal, the high frequency signal input from the first terminal being output from the second terminal, the high frequency signal input from the second terminal being output from the third terminal:
an antenna for transmission/reception that is connected to the second terminal; and
a mixer that is connected to an output terminal of the other of the output side high frequency transmission lines of the selector switch and the third terminal, for mixing the high frequency signal that is output from the output terminal of the other of the output side high frequency transmission lines and a high frequency signal received at the antenna for transmission/reception and outputting an intermediate frequency signal.

10. A high frequency transmitting/receiving apparatus comprising:
a high frequency oscillator for generating-a high frequency signal;
the selector switch of claim 5, whose input terminal is connected to the high frequency oscillator,for selectively outputting the high frequency signal supplied from the high frequency oscillator, from the one and the other output side high frequency transmission line;
an antenna for transmission that is connected to an output terminal of the one of the high frequency transmission lines;
an antenna for reception; and
a mixer that is connected to an output terminal of the other of the output side high frequency transmission lines of the selector switch and the antenna for reception, for mixing the high frequency signal that is output from the output terminal of the other of the output sire high frequency transmission lines and a high frequency signal received at the antenna for reception and outputting an intermediate frequency signal.

11. A radar apparatus comprising:
the high frequency transmitting/receiving apparatus of claim 7; and
a distance information detecting device for processing the intermediate frequency signal output from the high frequency transmitting/receiving apparatus and detecting information on a distance up to an object to be detected.

12. A radar apparatus comprising:
the high frequency transmitting/receiving apparatus of claim 8; and
a distance information detecting device for processing the intermediate frequency signal output from the high frequency transmitting/receiving apparatus and detecting information on a distance up to an object to be detected.

13. A radar apparatus comprising:
the high frequency transmitting/receiving apparatus of claim 9; and
a distance information detecting device for processing the intermediate frequency signal output from the high frequency transmitting/receiving apparatus and detecting information on a distance up to an object to be detected.

14. A radar apparatus comprising:
the high frequency transmitting/receiving apparatus of claim 10; and
a distance information detecting device for processing the intermediate frequency signal output from the high frequency transmitting/receiving apparatus and detecting information on a distance up to an object to be detected.

15. A radar apparatus-mounting vehicle comprising the radar apparatus of claim 11, which is used to detect an object to be detected.

16. A radar apparatus-mounting vehicle comprising the radar apparatus of claim 12, which is used to detect an object to be detected.

17. A radar apparatus-mounting vehicle comprising the radar apparatus of claim 13, which is used to detect an object to be detected.

18. A radar apparatus-mounting vehicle comprising the radar apparatus of claim 14, which is used to detect an object to be detected.

19. A radar apparatus-mounting small ship comprising the radar apparatus of claim 13, which is used to detect an object to be detected.

20. A radar apparatus-mounting small ship comprising the radar apparatus of claim 14, which is used to detect an object to be detected.
